(19) United States
(12) Patent Application Publication
(10) Pub. No.: US 2022/0294077 A1
(43) Pub. Date: Sep. 15, 2022

(54) ELECTRODE GROUP, SECONDARY BATTERY, BATTERY PACK, VEHICLE, AND STATIONARY POWER SUPPLY

(71) Applicant: Kabushiki Kaisha Toshiba, Tokyo (JP)

(72) Inventors: Yasuyuki HOTTA, Ota (JP); Takashi KUBOKI, Ota (JP); Shinsuke MATSUNO, Minato (JP); Norio TAKAMI, Yokohama (JP)

(73) Assignee: Kabushiki Kaisha Toshiba, Tokyo (JP)

(21) Appl. No.: 17/446,864

(22) Filed: Sep. 3, 2021

(30) Foreign Application Priority Data
Mar. 12, 2021 (JP) 2021-040495

(51) Int. Cl. H01M 50/446; H01M 50/431; H01M 50/426

(52) U.S. Cl. CPC H01M 50/446; H01M 50/431; H01M 50/426; H01M 2220/20

(57) ABSTRACT

An electrode group includes a negative electrode, a positive electrode and a separator. The negative electrode includes a negative electrode active material-containing layer and a mesh negative electrode current collector. The positive electrode includes a positive electrode active material-containing layer. The separator includes a composite membrane containing inorganic solid particles and a polymer material. At least one of a first polymer material constituting the negative electrode active material-containing layer is the same as a second polymer material. A ratio a/b of denseness a and denseness b is greater than 1.05. A peeling strength σ1 is greater than a peeling strength σ2. An air permeability coefficient of a joined body of the composite membrane and the negative electrode is 1×10⁻¹⁹ m² or more and 1×10⁻¹⁵ m² or less.

### CROSS-REFERENCE TO RELATED APPLICATIONS

This application is based upon and claims the benefit of priority from Japanese Patent Application No. 2021-040495 filed on Mar. 12, 2021, and the entire contents of which are incorporated herein by reference.

### FIELD

Embodiments described herein relate generally to an electrode group, a secondary battery, a battery pack, a vehicle, and a stationally power supply.

### BACKGROUND

Non-aqueous electrolyte batteries such as lithium-ion batteries are used as power suppliers in a wide range of fields.

The forms of the non-aqueous electrolyte batteries range from small ones for various electronic devices or the like to large ones for electric vehicles.

Since the non-aqueous electrolyte batteries use non-aqueous electrolytes containing flammable substances such as ethylene carbonate, safety measures are required.

Development of an aqueous electrolyte battery using an aqueous electrolyte containing a non-flammable aqueous solvent instead of a non-aqueous electrolyte is underway.

### BRIEF DESCRIPTION OF THE DRAWINGS

FIG. 1 is a cross-sectional view schematically illustrating an example of an electrode group according to an embodiment.

FIG. 2 is a partially enlarged view of a portion where a negative electrode active material-containing layer and a composite membrane provided in the electrode group according to the present embodiment are joined.

FIGS. 3A and 3B are cross-sectional views schematically illustrating an example of a separator according to an embodiment.

FIG. 4 is a partially enlarged view of the separator illustrated in FIG. 3.

FIG. 5 is a cross-sectional view schematically illustrating an example of a secondary battery according to an embodiment.

FIG. 6 is a cross-sectional view of the secondary battery illustrated in FIG. 3 along the line IV-IV line.

FIG. 7 is a partially cut perspective view schematically illustrating another example of the secondary battery according to the embodiment.

FIG. 8 is an enlarged cross-sectional view of part B of the secondary battery illustrated in FIG. 7.

FIG. 9 is a perspective view schematically illustrating an example of an assembled battery according to an embodiment.

FIG. 10 is a perspective view schematically illustrating an example of a battery pack according to an embodiment.

FIG. 11 is an exploded perspective view schematically illustrating another example of the battery pack according to the embodiment.

FIG. 12 is a block diagram illustrating an example of an electric circuit of the battery pack illustrated in FIG. 11.

FIG. 13 is a partial transparency view schematically illustrating an example of a vehicle according to an embodiment.

FIG. 14 is a block diagram illustrating an example of a system including a stationary power supply according to an embodiment.

### DETAILED DESCRIPTION

Generally, a potential window of an aqueous electrolyte is narrower than a non-aqueous potential window.

Therefore, in an aqueous electrolyte battery, depending on a combination of a positive electrode and a negative electrode, water in the aqueous electrolyte may be electrolyzed at the time of initial charging.

Therefore, a separator used in an aqueous electrolyte battery is required to prevent water from coming into contact with an electrode, that is, to have a high denseness that exhibits a high water shielding property.

In addition, in a secondary battery using lithium metal or zinc metal for an electrode and a secondary battery using an electrolyte containing lithium ion or zinc ion, respectively, there is a risk that precipitates such as lithium dendrite and zinc dendrite are generated on an electrode by charging and discharging. When these dendrites break through the separator, an internal short circuit can occur. Denseness is required for the separator from the viewpoint of making it difficult for these dendrites to break through.

In particular, examples of the separator having a high denseness include a solid electrolyte membrane. The solid electrolyte membrane is a membrane composed only of solid electrolyte particles having ionic conductivity. The solid electrolyte membrane is impermeable to solvents and can selectively permeate only specific ions, and therefore, has a complete water shielding property. However, the solid electrolyte membrane has low flexibility, and therefore, its durability is not sufficient. In addition, in order to use the solid electrolyte membrane as the separator, it is necessary to have a certain thickness or more, so that it is difficult to increase an energy density of a battery.

In order to solve this problem, a polymer composite membrane in which solid electrolyte particles are joined to each other by a polymer material has been proposed. The polymer composite membranes do not show as complete water shielding properties as solid electrolyte membranes, but have high denseness and can be impregnated with a trace amounts of aqueous electrolyte. In addition, the polymer composite membrane has more excellent flexibility and can be made thinner than the solid electrolyte membrane.

However, when such a composite electrolyte membrane is used as a separator, it is difficult for the electrolyte to sufficiently reach the inside of the electrode due to the high denseness, and the operation of the secondary battery cannot be sufficiently performed. Therefore, an adhesion between the electrode active material-containing layer and the current collector may be adjusted, but when the adhesion between the electrode active material-containing layer and the current collector is low, there is a problem with the conductivity of the interface between the electrode active material-containing layer and the current collector.

Hereinafter, embodiments will be described. Unless otherwise noted, pH and values obtained by other measurements are those measured at atmospheric pressure and 25° C.

### First Embodiment

According to a first embodiment, an electrode group includes a negative electrode including a negative electrode active material-containing layer and a mesh negative electrode current collector, and at least a part of the mesh negative electrode current collector existing inside the negative electrode active material-containing layer, a positive electrode including a positive electrode active material-containing layer, and a separator including a composite membrane containing inorganic solid particles and a polymer material. The composite membrane has a first surface joined to the negative electrode active material-containing layer and a second surface joined to the positive electrode active material-containing layer, and at least one of the first polymer materials constituting the negative electrode active material-containing layer is the same as a second polymer material constituting the composite membrane. A ratio a/b of a density a of 20% of composite membrane from the second surface toward the first surface and a density b of 20% of composite membrane from the first surface toward the second surface is greater than 1.05, a peeling strength σ1 of an interface between the composite membrane and the negative electrode active material-containing layer is greater than a peeling strength σ2 of the interface between the composite membrane and the positive electrode active material-containing layer, and an air permeability coefficient of the joined body of the composite membrane and the negative electrode is 1×10⁻¹⁹ m² or more and 1×10⁻¹⁵ m² or less.

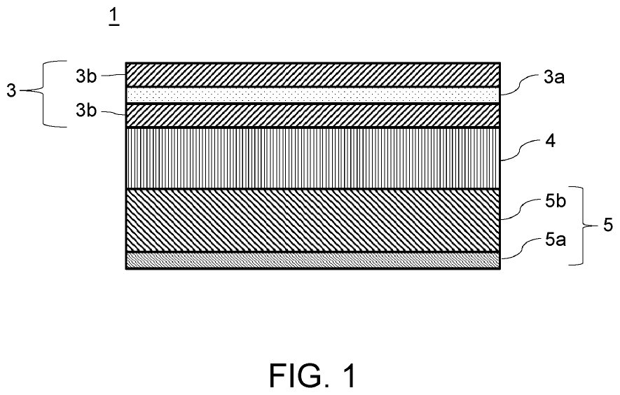

FIG. 1 is a cross-sectional view schematically illustrating an example of an electrode group according to an embodiment. An electrode group 1 illustrated in FIG. 1 includes a negative electrode 3, a positive electrode 5, and a composite membrane 4 located between the negative electrode 3 and the positive electrode 5. The negative electrode 3 includes a mesh negative electrode current collector 3a and a negative electrode active material-containing layer 3b. At least a part of the mesh negative electrode current collector 3a is provided inside the negative electrode active material-containing layer 3b. In FIG. 1, the mesh negative electrode current collector 3a cannot be observed from a main surface of the negative electrode 3, but can be observed from a side surface. The composite membrane 4 is a separator having at least a structure in which inorganic solid particles are linked by a polymer material, and the composite membrane includes a composite layer. The composite layer contains inorganic solid particles and a polymer material. The composite membrane may include only the composite layer, or may further contain a base material. The negative electrode 3, the composite membrane 4, and the positive electrode 5 constitute the electrode group 1. The positive electrode 5 includes a positive electrode current collector 5a and a positive electrode active material-containing layer 5b supported on one surface of the positive electrode current collector 5a. The first polymer material and the second polymer material are collectively called polymer material.

In the present embodiment, the electrode group includes a positive electrode, a negative electrode, and a separator. In the present embodiment, a joined body of the negative electrode and the composite membrane is referred to as an electrode structure.

The electrode group according to the present embodiment can realize a secondary battery that exhibits high charge/discharge efficiency, improved rate characteristics, and suppressed self-discharge.

In the electrode group having the above configuration, by using the mesh negative electrode current collector for the negative electrode, a negative electrode active material can exist between conductive parts of the mesh negative electrode current collector. Therefore, a contact area between the negative electrode active material and the current collector can be increased, so it is possible to improve the conductivity of the interface between the negative electrode active material and the mesh negative electrode current collector, and it is also possible to form a thick negative electrode active material-containing layer per layer, which is also advantageous in terms of energy density. In addition, the adhesion between the composite membrane that functions as a separator and the negative electrode becomes high, and twisting of the above-described separator and generation of a space are unlikely to occur. Therefore, in the secondary battery using this electrode group, the cell resistance is reduced and the self-discharge is suppressed. In addition, such a secondary battery can exhibit high charge/discharge efficiency and rate characteristics. The mesh negative electrode current collector will be described later.

In the secondary battery using the composite membrane, which contains inorganic solid particles and a polymer material, as the separator, a liquid electrolyte or an electrolyte solvent may infiltrate into a small gap between the inorganic solid particles and the polymer material, which becomes a lithium ion (Li⁺) conduction path. When the aqueous electrolyte is used, the water in the electrolyte is bound to some extent, but can move inside the composite membrane or can be effused out of the composite membrane. Therefore, when the adhesion at the interface between the composite membrane and the negative electrode is low, a liquid pool due to water derived from the aqueous electrolyte may occur at the interface. Many water molecules that become reactants in an electrolysis reaction of water are concentrated in this liquid pool, and the progress of the electrolysis reaction toward a product side containing hydrogen is promoted. For example, hydrogen can be generated due to water accumulated in the interface between the composite membrane and the negative electrode.

In the electrode group according to the present embodiment, a peeling strength σ1 at an interface (first surface) between the negative electrode active material-containing layer and the composite membrane is greater than a peeling strength σ2 at an interface (second surface) between the positive electrode active material-containing layer and the composite membrane, satisfying the relationship of σ1>σ2, thus the adhesion between the negative electrode and the composite membrane becomes high. Therefore, the composite membrane is hard to twist. Therefore, in a secondary battery using the electrode group, a large amount of electrolyte liquid (for example, the liquid electrolyte, the electrolyte solvent, or the like) does not accumulate on the interface (first surface) between the negative electrode active material-containing layer and the composite membrane. When the electrode group is used, for example, in the secondary battery containing the aqueous electrolyte, the self-discharge associated with the electrolysis of the aqueous solvent in the negative electrode can be suppressed. In addition, stress occurs at the interface between the negative electrode active material-containing layer and the composite membrane and the interface between the positive electrode active material-containing layer and the composite membrane due to the volume change in the electrode according to charging and discharging, but when σ1>σ2, the stress is preferentially released at the interface between the positive electrode active material-containing layer and the composite membrane, and the interface structure between the negative electrode active material-containing layer and the composite membrane is maintained. The peeling strength σ1 and the peeling strength σ2 can satisfy the relationship of σ1>1.5×σ2, and further the relationship of σ1>10×σ. That is, the peeling strength σ1 may exceed 1.5 times the peeling strength σ2, and the peeling strength σ1 may exceed 10 times the peeling strength σ2.

The negative electrode active material-containing layer and the composite membrane are bound on the first surface. The peeling strength σ1 on the first surface indicates a degree of binding between the negative electrode active material-containing layer and the composite membrane. That is, since the electrode group satisfies the relationship of σ1>σ2, the degree of binding between the negative electrode active material-containing layer and composite membrane are higher than that between the positive electrode active material-containing layer and the composite membrane. When the negative electrode and the separator (not limited to the composite membrane) are simply laminated, there is a limit to the surface contact between the two at those interfaces and it is difficult to avoid the formation of the liquid pool of the electrolyte. In such an electrode group, since the negative electrode and the composite membrane are bound to each other, the liquid pool is not formed and a region containing a large amount of water can be reduced. Therefore, the contact between the water in the electrolyte and the material contained in the electrode is reduced, and the electrolysis of water is suppressed.

The peeling strength σ2 in the second surface of the positive electrode active material-containing layer and the composite membrane can be zero. That is, it may be simply laminated. This is because the electrolysis of the water solvent is unlikely to occur on the positive electrode side, and even if a puddle is generated at the gap of the interface between the composite membrane and the positive electrode, the self-discharge reaction on the surface of the positive electrode is difficult to proceed.

When the degree of binding between the negative electrode active material-containing layer and the composite membrane is less than or equal to the degree of binding between the positive electrode active material-containing layer and the composite membrane, that is, when σ1≤σ2, it is not preferable because the amount of water existing between the composite membrane and the negative electrode active material-containing layer is increased.

The peeling strengths σ1 and σ2 are almost the same between when the values are measured from the electrode structure of a joined body of the composite membrane and the negative electrode and when the ones assembled in the secondary battery are disassembled and measured. Therefore, the value measured from the electrode structure can be regarded as the same as the value obtained by decomposing the secondary battery, and vice versa.

It is preferable that the fluctuation of the peeling strength σ1 on the first surface of the negative electrode active material-containing layer and the composite membrane is not large. Specifically, it is preferable that the peeling strength σ1 decreases by 100% or less at 10% or less per 1 mm of length along the first surface of the electrode group. That is, it is preferable that the portion where the peeling strength σ1 deviates by 100% or more in the negative direction remains at 10% or less of the 1 mm length, for every 1 mm along the first surface. Here, the negative direction means the negative direction with respect to the positive thickness direction when the negative electrode current collector exists is the positive thickness direction. In this way, in the electrode group in which the fluctuation of the peeling strength σ1 on the first surface is not large, the peeling strength σ1 is maintained high along the first surface, and the twisting of the composite membrane and the liquid pool are less likely to occur.

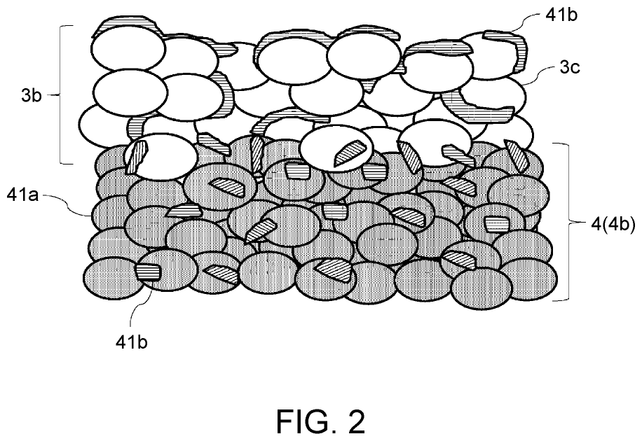

FIG. 2 is a partially enlarged view of a portion where the negative electrode active material-containing layer and the composite membrane provided in the electrode group according to the present embodiment are joined. In the electrode group according to the present embodiment, the negative electrode active material-containing layer 3b and the composite membrane 4 are adhered to each other by the polymer material contained therein, and at least one of the polymer material 41b contained in the negative electrode active material-containing layer 3b is the same as the polymer material 41b contained in the composite membrane 4. As a result, compared with the electrode group in which the negative electrode active material-containing layer 3b and the composite membrane 4 are not bound by the polymer material, or the electrode group in which the negative electrode active material-containing layer 3b and the composite membrane 4 are bound by different materials, the strength of the electrode group can be further increased. Therefore, the peeling strength between the negative electrode active material-containing layer 3b and the composite membrane 4 can be improved. Further, in the electrode group according to the present embodiment, the film thickness of the composite membrane, that is, the separator can be reduced. Therefore, by making at least a part of the polymer material contained in the negative electrode active material-containing layer the same as the composite membrane, the internal resistance inside the secondary battery is reduced, and the volume and mass energy density of the secondary battery can be reduced. The polymer material may be read as a binder. The composite membrane may include a base material layer, but in this case, the composite membrane is the composite layer that is bound to the negative electrode active material-containing layer. Therefore, in the description that at least one of the polymer materials contained in the negative electrode active material-containing layer is the same as the polymer material contained in the composite membrane, at least one type of the polymer material contained in the negative electrode active material-containing layer can be read as being the same as the polymer material contained in the composite layer.

It can be confirmed whether the negative electrode active material-containing layer and the composite membrane have the same polymer material by analyzing the surface of the composite membrane and the first surface of the negative electrode active material-containing layer, respectively, by the microscopic attenuated total reflection (ATR) method.

In the electrode group according to the present embodiment, a dense layer is formed on the surface of the composite membrane on a side in contact with the positive electrode active material-containing layer and a side in contact with the negative electrode active material-containing layer, and a ratio a/b of density a of 20% thickness from the surface facing the positive electrode active material-containing layer and density b of 20% thickness from the surface facing the negative electrode active material-containing layer is greater than 1.05 (a/b>1.05).

The electrode group according to the embodiment includes composite membranes having different denseness along the thickness direction. The density is greater than 0% and can take a value of 100% or less. As the density approaches 0%, the number of voids is increased and the density is sparse, and as the density approaches 100%, the number of voids is decreased and the density is dense. The first surface side of the composite membrane, that is, the side in contact with the negative electrode active material-containing layer has more voids and is sparser than the second surface side, that is, the side in contact with the positive electrode active material-containing layer. By being sparse on the first surface side, it is possible to absorb the stress caused by the volume change due to charge and discharge of the negative electrode active material and prevent the deterioration of σ1. Therefore, it is difficult for the electrolyte solvent to permeate on the first surface side, and it is difficult to break through with dendrites such as lithium or zinc. On the other hand, due to the presence of voids on the first surface side of the composite layer, the electrolyte can be maintained, and the infiltration or movement of water or hydrogen ions is suppressed on the second surface side with high denseness. Therefore, the separator according to the embodiment can have both high denseness and electrolyte impregnation property.

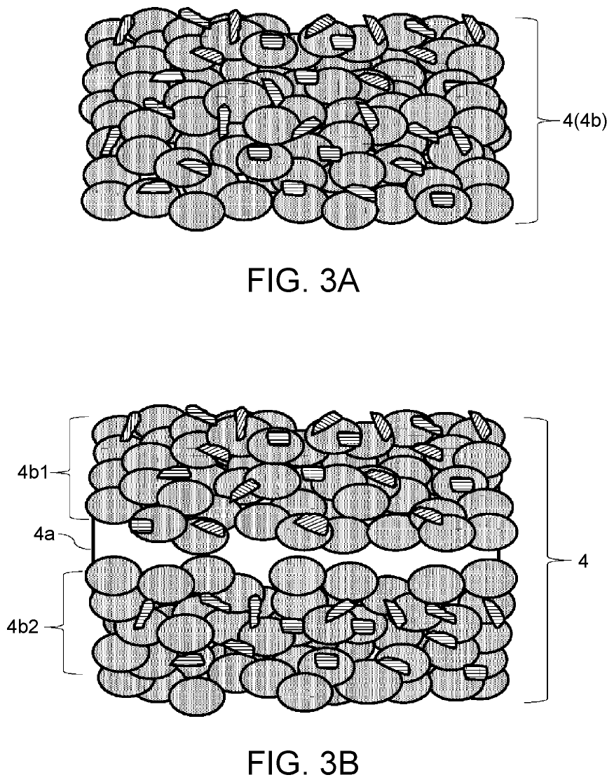

FIG. 3 is a cross-sectional view schematically illustrating an example of a separator according to an embodiment. The separator illustrated in FIG. 3A includes the composite membrane 4. The composite membrane 4 includes only a composite layer 4b. The separator illustrated in FIG. 3B includes the composite membrane 4 that includes a base material layer 4a. The composite membrane 4 illustrated in FIG. 3b has a form in which the base material layer 4a is sandwiched between the composite layers 4b. In this way, a first composite layer 4b1 may be provided on the surface of the base material layer 4a, and a second composite layer 4b2 may be provided on the other surface. In the description, the case where the composite membrane includes only the composite layer will be described. The composite layer may indicate the first composite layer or both the first composite layer and the second composite layer.

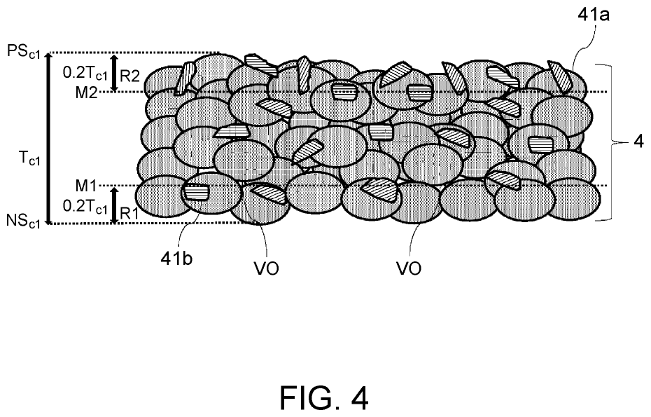

FIG. 4 is a partially enlarged view of the separator illustrated in FIG. 3. As illustrated in FIG. 4, the composite membrane has a first surface NS_{C1} in contact with the negative electrode active material-containing layer and a second surface PS_{C1} in contact with the positive electrode active material-containing layer. The first surface NS_{C1} is located on an opposite side of the second surface PS_{C1}. That is, the first surface NS_{C1} can be the first surface, and the second surface PS_{C1} can be the second surface. A length from the first surface NS_{C1} to the second surface PS_{C1} is a thickness T_{C1} of the composite membrane. In the composite membrane, inorganic solid particles 41a are bound to each other by polymer materials 41b. The composite membrane is provided with a pore VO (void) that does not contain either the inorganic solid particles 41a or the polymer materials 41b. The pore VO is provided on the first surface NS_{C1} side in contact with the negative electrode active material-containing layer rather than the second surface PS_{C1} side on an inner side in contact with the positive electrode active material-containing layer. The composite membrane may have a structure in which the denseness gradually increases from the NS_{C1} side of the first surface in contact with the negative electrode active material-containing layer toward the side in contact with the positive electrode active material-containing layer, and may have a two-layer structure of a side in contact with the negative electrode active material-containing layer and a side in contact with the positive electrode active material-containing layer, or may have a multi-layer structure. The density in an intermediate portion between the density a and the density b of the composite layer may decrease from the density a toward the density b as described above, or may hardly change or may almost unchange. In addition, the decrease and increase may be repeated several times from the density a to the density b. However, the density of the intermediate portion is greater than or equal to the density b and less than or equal to the density a. This is also the case when there is a base material layer in between.

A surface roughness Ra of the side in contact with the electrode of the composite membrane, that is, the first surface and the second surface, is preferably 0.05 μm or more and 1 μm or less. A better range is 0.1 μm or more and 0.3 μm or less.

In the composite membrane, a ratio of a second density PD_{C1} (density a) to a first density ND_{C1} (density b) (PD_{C1}/ND_{C1}), that is, a/b is greater than 1.05 (a/b>1.05). The first density ND_{C1} is a ratio occupied by a portion other than the pore VO in a region from the first surface NS_{C1} to a first surface M1 located at a depth of 0.2 T_{C1} with respect to the thickness T_{C1} of the composite membrane. The second density PD_{C1} is a ratio occupied by a portion other than the pore VO in a region from the second surface PS_{C1} to a second surface M2 located at the depth of 0.2 T_{C1} with respect to the thickness T_{C1} of the composite membrane. The portion other than the pore VO is typically the portion where the inorganic solid particles 41a and the polymer material 41b are present.

It can be said that the higher the first density ND_{C1} and the second density PD_{C1}, the higher the denseness of the side of the composite membrane in contact with the positive electrode active material-containing layer and the side of the composite membrane in contact with the negative electrode active material-containing layer. In addition, it can be said that the higher the ratio PD_{C1}/ND_{C1}, the lower the denseness of the composite membrane on the side in contact with the negative electrode active material-containing layer than the denseness of the side in contact with the positive electrode active material-containing layer. The ratio PD_{C1}/ND_{C1} is preferably 1.01 or more. There is no particular upper limit for the ratio PD_{C1}/ND_{C1}, but is 1.2 or less as one example.

A separator with a low first density ND_{C1} tends to have high electrolyte impregnation. The first density ND_{C1} is preferably 97% or less, and more preferably 95% or less. On the other hand, a separator with a high first density ND_{C1} tends to have a high denseness. The first density ND_{C1} is preferably 50% or more, more preferably 70% or more, and still more preferably 90% or more.

A separator with a low second density PD_{C1} tends to have high ionic conductivity. The second density PD_{C1} is preferably 99% or less, and more preferably 98% or less. A separator with a high second density PD_{C1} tends to have high denseness. The second density PD_{C1} is preferably 80% or more, more preferably 90% or more, and still more preferably 95% or more.

The first density ND_{C1} and the second density PD_{C1} are measured by, for example, the following method. First, the secondary battery is disassembled and the separator is collected. A part of the collected separator is cut out, washed and dried to obtain a test piece. The test piece is cut out by argon milling in a direction parallel to the thickness direction to obtain a cross section. The obtained cross section is illustrated in FIG. 4, for example. The cross section is observed with a scanning electron microscope (SEM) to determine the second surface PS_{C1} and the first surface NS_{C1} of the composite membrane, and the thickness T_{C1} of the composite membrane is measured.

The second surface PS_{C1} and the first surface NS_{C1} of the composite membrane are surfaces parallel to the thickness direction of the composite membrane 4, respectively, and are surfaces located on the outermost surface. At this time, in the cross section, the second surface PS_{C1} and the first surface NS_{C1} may have a protrusion. This is due to agglomerates (aggregates) of the inorganic solid particles existing in the separator. In addition, when the base material layer is included, a part of the composite layer may enter the base material layer. In these cases, the portion parallel to the direction orthogonal to the thickness direction of the composite membrane 4 excluding the protrusion is defined as the second surface PS_{C1}. Further, even in the first surface NS_{C1}, as in the case of the second surface PS_{C1}, the portion parallel to the direction orthogonal to the thickness direction of the composite membrane 4 excluding the protrusion is defined as the first surface NS_{C1}.

Next, an image of a region R1 illustrated in FIG. 4 is cut out from the cross-sectional image. The cross-sectional image is obtained by SEM observation at a magnification of 5000 times. The region R1 is the region R1 from the first surface NS_{C1} to the first surface M1. The first surface M1 is a surface which is between the first surface NS_{C1} and the second surface PS_{C1} and located at a depth of 0.2 T_{C1} from the first surface NS_{C1} with respect to the thickness T_{C1} of the composite membrane. In other words, the region R1 is a region which is located at an end portion of the first surface NS_{C1} side in the cross section of the composite membrane and occupies 20% of an area on the surface side of the composite membrane 4.

Next, an image of a region R2 illustrated in FIG. 4 is cut out from the cross-sectional image. The cross-sectional image is obtained by SEM observation at a magnification of 5000 times. The region R2 is the region from the second surface PS_{C1} to the second surface M2 in the composite membrane. The second surface M2 is a surface which is between the second surface PS_{C1} and the first surface NS_{C1} and located at a depth of 0.2 T_{C1} from the second surface PS_{C1} with respect to the thickness T_{C1} of the composite membrane. In other words, the region R2 is a region which is located at the end portion of the positive electrode active material-containing layer side in the cross section of the composite membrane, and occupies 20% of the area on the positive electrode active material-containing layer side of the composite membrane 4.

Next, the brightness of the images in regions R1 and R2 is normalized. These normalized images are converted into two gradations so that a pore portion and a portion other than the pore portion (hereinafter referred to as a filling portion) can be distinguished. In the image of the region R1 that is converted into two gradations, the ratio occupied by the filling portion is calculated, which is defined as the first density ND_{C1}. Similarly, in the image of the region R2 that is converted into two gradations, the ratio occupied by the filling portion is calculated, which is defined as the second density PD_{C1}.

Even when the densities a and b are measured from the electrode group, even if the assembled battery is disassembled and measured, the values almost unchange. Therefore, the values measured from the electrode group can be regarded as the same as the value obtained by decomposing the secondary battery, and vice versa.

The same measurement can be performed with a composite membrane having the first composite layer, the base material layer, and the second composite layer. Specifically, the densities a and b of the first composite layer are obtained by the above method, and similarly, the densities a and b of the second composite layer are also obtained by the above method. By being separated by the base material layer in this way, the densities a and b of each of the first and second composite layers are obtained. Of the densities of each composite layer, the density on the side opposite to the base material layer side is used to obtain the ratio a/b. For example, when the negative electrode, the first composite layer, the base material, the second composite layer, and the positive electrode are laminated in this order, the ratio a/b is calculated using the density b of the first composite layer and the density a of the second composite layer.

By having such a density, it is possible to obtain a separator having excellent impregnation property of the electrolyte while having durability. The excellent impregnation property of the electrolyte can reduce the resistance inside the cell.

Here, a specific configuration of the electrode group according to the present embodiment will be described.

### (Negative Electrode)

The negative electrode included in the electrode group includes the negative electrode active material-containing layer and the mesh negative electrode current collector. At least a part of the mesh negative electrode current collector exists inside the negative electrode active material-containing layer. The presence of at least a part of the inside of the negative electrode active material-containing layer may include, for example, when the negative electrode is observed, the case where only the negative electrode active material-containing layer can be observed and the mesh negative electrode current collector cannot be observed, and the case where the mesh negative electrode current collector can also be observed. The case where only the negative electrode active material-containing layer is observed is, for example, the case where the mesh negative electrode current collector is included in the negative electrode active material-containing layer. In this case, the mesh negative electrode current collector is entirely surrounded by the members constituting the negative electrode active material-containing layer.

The case where the mesh negative electrode current collector can also be observed is the case where the mesh negative electrode current collector is observed when the negative electrode is observed as a whole. In this case, the mesh negative electrode current collector has a portion not surrounded by the members constituting the negative electrode active material-containing layer.

Specifically, there may be the case where the mesh negative electrode current collector has a portions exposed from the negative electrode active material-containing layer and a portion not exposed from the same surface of the negative electrode, the case where a part of the negative electrode active material-containing layer exists between the conductive parts of the mesh negative electrode current collector because the mesh negative electrode current collector intrudes on the negative electrode active material-containing layer, or the like, but it is not limited to these. In these cases, at least a part of the mesh negative electrode current collector exists inside the negative electrode active material-containing layer. The mesh negative electrode current collector can be embedded in the negative electrode active material-containing layer. The negative electrode active material-containing layer contains the negative electrode active material. The current collector is sometimes called a negative electrode current collector.

One side of the surface of the negative electrode active material-containing layer contacts the composite layer.

The negative electrode active material-containing layer contains a negative electrode active material and optionally a conductive agent and a binder. It is preferable that the negative electrode active material-containing layer contains the negative electrode active material containing a compound whose lithium ion insertion-desorption potential is 1 V or more and 3 V or less (vs. Li/Li⁺) with respect to the lithium ion oxidation-reduction potential.

In an aqueous electrolyte battery including a negative electrode containing a compound whose lithium ion insertion-desorption potential is within the above range in the negative electrode active material, at the time of initial charging, water contained in the solvent of the aqueous electrolyte may be electrolyzed inside the negative electrode and in the vicinity of the negative electrode. This is because the potential of the negative electrode decreases due to the insertion of lithium ions into the negative electrode active material during the initial charging. When the negative electrode potential decreases below the hydrogen generation potential, some water is decomposed into hydrogen (H₂) and hydroxide ions (OH⁻) inside the negative electrode and in the vicinity of the negative electrode. As a result, the pH of the aqueous electrolyte existing inside the negative electrode and in the vicinity of the negative electrode is increased.

The hydrogen generation potential of the negative electrode depends on the pH of the aqueous electrolyte. That is, when the pH of the aqueous electrolyte in contact with the negative electrode is increased, the hydrogen generation potential of the negative electrode is decreased. In the battery using the negative electrode active material whose lower limit of lithium ion insertion-desorption potential is 1 V or more (vs. Li/Li⁺), the potential of the negative electrode is lower than the hydrogen generation potential at the time of initial charging, but after the initial charging, the potential of the negative electrode tends to be higher than the hydrogen generation potential, so that water decomposition in the negative electrode is less likely to occur.

As described above, in the electrode group according to the present embodiment, it is difficult for a liquid pool of water to be formed on the first surface where the negative electrode surface on the separator side is located. This also means that it is difficult for water to be infiltrated into the first surface from the outside of the electrode group. Therefore, in a battery in which the electrode group is used as a composite member of the negative electrode and the separator, the pH of the aqueous electrolyte existing in the negative electrode and in the vicinity of the negative electrode can be maintained at a high state after the initial charging. Therefore, when the compound having the lower limit of the lithium ion insertion-desorption potential of 1 V or more (vs. Li/Li⁺) is used as the negative electrode active material to be included in the active material-containing layer of the electrode group, the secondary battery with high capacity and excellent stability can be realized.

Examples of compounds in which the lithium ion insertion-desorption potential is a potential based on the oxidation-reduction potential of lithium and is 1 V or more and 3 V or less (vs. Li/Li⁺) include titanium oxide and titanium-containing oxide. Examples of the titanium-containing oxide include lithium titanium composite oxide, niobium titanium composite oxide, and sodium niobium titanium composite oxide. The negative electrode active material can contain one or more titanium oxides and titanium-containing oxides.

Examples of titanium oxides include monoclinic titanium oxides, rutile titanium oxides, and anatase titanium oxides. The composition of titanium oxide of each crystal structure can be represented by TiO₂ before charging and Li_{y}TiO₂ after charging (subscript y is 0≤y≤1). Further, the pre-charging structure of titanium oxide having a monoclinic structure can be expressed as TiO₂(B).

Examples of the lithium titanium oxide include lithium titanium oxide having a spinel structure (for example, a compound represented by a general formula Li₄₊ⱼTi₅O₁₂ with −1≤j≤3), lithium titanium oxide having a rams delite structure, (for example, Li₂₊ⱼTi₃O₇ with −1≤j≤3), a compound represented by Li_{1+y}Ti₂O₄ with 0≤y≤1, a compound represented by Li_{1.1+y}Ti_{1.8}O₄ with 0≤y≤1, a compound represented by Li_{1.07+y}Ti_{1.86}O₄ with 0≤y≤1, and a compound represented by LiₖTiO₂ with 0<k≤1. Further, the lithium titanium oxide may be a lithium titanium composite oxide in which a different kind of element is introduced.

The niobium-titanium composite oxide is represented by, for example, Li_{χ}TiMe_{α}Nb_{2±β}O_{7±σ} with 0≤χ≤5, 0≤α≤0.3, 0≤β≤0.3, and 0≤σ≤0.3, and Me contains one or more compounds selected from the group of Fe, V, Mo, and Ta.

The sodium niobium titanium composite oxide includes orthorhombic Na-containing niobium-titanium composite oxide that is represented by, for example, the general formula Li_{2+d}Na₂₋ₑMe1_{f}Ti_{6-g-h}Nb_{g}Me2ₕO_{14-δ} with 0≤d≤4, 0≤e≤2, 0≤f<2, 0<g<6, 0≤h<3, and −0.5≤δ5≤0.5, Me1 contains one or more selected from Cs, K, Sr, Ba, and Ca, and Me2 contains one or more selected from Zr, Sn, V, Ta, Mo, W, Fe, Co, Mn, and Al.

The negative electrode included in the electrode group preferably uses a titanium oxide having an anatase structure, a titanium oxide having a monoclinic structure, a lithium titanium oxide having a spinel structure, a niobium titanium composite oxide, or a mixture thereof as a negative electrode active material. On the other hand, when the titanium oxide having the anatase structure, the titanium oxide having the monoclinic structure, or the lithium titanium oxide having the spinel structure is used as the negative electrode active material, for example, the electrode group can obtain a high electromotive force by combining with the positive electrode using the lithium manganese composite oxide. On the other hand, high capacity can be exhibited by using the niobium-titanium composite oxide.

The negative electrode active material can be included in the active material-containing layer, for example, in the form of particles. Negative electrode active material particles can be primary particles, secondary particles that are aggregates of primary particles, or a mixture of single primary particles and secondary particles. The shape of the particles is not particularly limited and may be, for example, spherical, elliptical, flat, or fibrous.

Secondary particles of the negative electrode active material can be obtained, for example, by the following method. First, the negative electrode active material raw material is reacted and synthesized to prepare a negative electrode active material precursor having an average particle size of 1 μm or less. Thereafter, the negative electrode active material precursor is fired and crushed using a crusher such as a ball mill or a jet mill. Next, in the firing process, the negative electrode active material precursor is aggregated and grown into secondary particles having a large particle size.

The average particle size (diameter) of the secondary particles of the negative electrode active material is preferably 3 μm or more, and more preferably 5 μm or more and 20 μm or less. Within this range, a surface area of the negative electrode active material is small, so the decomposition of water can be further suppressed.

It is desirable that the average particle size of the primary particles of the negative electrode active material is 1 μm or less. As a result, a diffusion distance of Li ions inside the negative electrode active material is shortened, and a specific surface area is increased. Therefore, excellent high input performance (quick charging) can be obtained. On the other hand, if the average particle size of the primary particles of the negative electrode active material is small, particle agglomeration (aggregation) is likely to occur. When the particles of the negative electrode active material are agglomerated, the aqueous electrolyte tends to be unevenly distributed on the electrode in the secondary battery, which may lead to the depletion of ionic species in the positive electrode. Therefore, the average particle size of the primary particles of the negative electrode active material is preferably 0.001 μm or more. The average particle size of the primary particles of the negative electrode active material is more preferably 0.1 μm or more and 0.8 μm or less.

The primary particle size and the secondary particle size mean the particle size at which the volume integration value is 50% in a particle size distribution obtained by a laser diffraction type particle size distribution measuring device. As the laser diffraction type particle size distribution measuring device, for example, Shimadzu SALD-300 is used. In the measurement, the luminous intensity distribution is measured 64 times at 2-second intervals. As a sample for this particle size distribution measurement, a dispersion diluted with N-methyl-2-pyrrolidone is used so that the concentration of active material particles is 0.1% by mass to 1% by mass. Alternatively, as a measurement sample, 0.1 g of active material is dispersed in 1 ml-2 ml of distilled water containing an interface activator, is used.

The specific surface area of the negative electrode active material by the BET method by adsorption of nitrogen (N₂) is, for example, in the range of 3 m²/g or more and 200 m²/g or less. When the specific surface area of the negative electrode active material is within this range, the affinity between the negative electrode and the aqueous electrolyte can be further increased. This specific surface area can be obtained, for example, by the same method as the method of measuring the specific surface area of the negative electrode active material-containing layer described later.

The porosity of the negative electrode active material-containing layer should be 20% or more and 50% or less. As a result, the negative electrode having excellent affinity with the aqueous electrolyte and having a high density can be obtained. The porosity of the negative electrode active material-containing layer is more preferably 25% or more and 40% or less.

The porosity of the negative electrode active material-containing layer can be obtained, for example, by the mercury intrusion method. Specifically, first, the pore distribution of the negative electrode active material-containing layer is obtained by the mercury intrusion method. The total pore amount is calculated from this pore distribution. Porosity can be calculated from the ratio of the total pore volume and the volume of the negative electrode active material-containing layer.

The specific surface area of the negative electrode active material-containing layer by the BET method by adsorption of nitrogen (N₂) is more preferably 3 m²/g or more and 50 m²/g or less. When the specific surface area of the negative electrode active material-containing layer is less than 3 m²/g, the affinity between the negative electrode active material and the aqueous electrolyte becomes low. As a result, the interface resistance of the negative electrode may be increased, and the output performance and charge/discharge cycle performance of the secondary battery may deteriorate. On the other hand, when the specific surface area of the negative electrode active material-containing layer exceeds 50 m²/g, the distribution of ion species ionized from the electrolyte salt contained in the aqueous electrolyte is biased toward the negative electrode, so a shortage of the ion species in the positive electrode is caused, thereby decreasing the output performance and charge/discharge cycle performance.

This specific surface area can be obtained, for example, by the following method. When the electrode group including the negative electrode active material-containing layer to be measured is incorporated in the secondary battery, the secondary battery is disassembled and a part of the negative electrode active material-containing layer is collected. In 77K (boiling point of nitrogen) nitrogen gas, the amount of nitrogen gas adsorbed (mL/g) of the sample for each pressure P is measured while gradually increasing the pressure P (mmHg) of the nitrogen gas. A value obtained by dividing the pressure P (mmHg) by a saturated vapor pressure P0 (mmHg) of nitrogen gas is a relative pressure P/P0, and the adsorption isotherm is obtained by plotting the amount of nitrogen gas adsorbed for each relative pressure P/P0. A BET plot is calculated from this nitrogen adsorption isotherm and the BET equation, and the specific surface area is obtained using this BET plot. Note that the BET multipoint method is used to calculate the BET plot.

A conductive agent is added as necessary to improve the current collecting performance and suppress the contact resistance between the negative electrode active material and the mesh negative electrode current collector. Examples of the conductive agents include carbonaceous materials such as acetylene black, ketjen black, graphite, and coke. The conductive agent may be used alone or in combination of two or more.

The binder has an action of binding the negative electrode active material and the conductive agent. As the binder, the polymer material containing in the composite layer of the composite membrane is used as at least one kind of binder. By using the same material as the polymer material used for the composite layer as the binder used for the negative electrode active material-containing layer, both degrees of binding, that is, peeling strength σ1 can be improved. The details of the polymer material of the composite layer will be described later. The binder may be one type or a mixture of two or more types. Examples of binders can use at least one selected from the group consisting of polytetrafluoroethylene (PTFE), polyvinylidene fluoride (PVdF), and cellulose polymers such as carboxymethyl cellulose (CMC), fluororubber, styrene butadiene rubbers, acrylic resins or copolymers thereof, polyacrylic acid, and polyacrylonitrile can be used, but is not limited thereto. As the binder, polymer material contained in the composite layer, which will be described later, can also be used.

The compounding ratios of the negative electrode active material, the conductive agent, and the binder in the negative electrode active material-containing layer are preferably in the range of 70% by mass or more and 95% by mass or less, 3% by mass or more and 20% by mass or less, and 2% by mass or more and 10% by mass or less, respectively. When the compounding ratio of the conductive agent is 3% by mass or more, the conductivity of the negative electrode active material-containing layer can be improved, and when compounding ratio of the conductive agent is 20% by mass or less, the decomposition of aqueous electrolyte on the surface of the conductive agent can be reduced. When the compounding ratio of the binder is 2% by mass or more, sufficient electrode strength can be obtained, and when the compounding ratio of the binder is 10% by mass or less, the insulating portion of the electrode can be reduced.

At least a part of the mesh negative electrode current collector exists inside the negative electrode active material-containing layer. The mesh negative electrode current collector has a mesh structure. The mesh structure refers to, for example, a structure in which a metal wire, which will be described later, is woven, or a structure in which a metal plate is punched to form a plurality of through holes. Therefore, the mesh negative electrode current collector has a space between the conductive parts. The negative electrode active material or the like can enter the space between the conductive portions. The conductive portion is a metal wire when the conductive portion is the mesh negative electrode current collector formed of the metal wire, and is a portion excluding a through hole in the mesh negative electrode current collector formed of the metal plate. The mesh negative electrode current collector may have a two-dimensional structure or a three-dimensional structure, that is, a non-woven fabric.

The mesh negative electrode current collector can include, at least in part, a portion that does not exist inside the negative electrode active material-containing layer at that location. This portion can serve as a current collecting tab. Alternatively, the current collecting tab separate from the mesh negative electrode current collector may be electrically connected to the electrode.

As the material of the mesh negative electrode current collector, in the electrode potential range when the alkali metal ion is inserted or desorbed, a substance that is electrochemically stable is used. The mesh negative electrode current collector is, for example, zinc foil, aluminum foil, or an aluminum alloy foil containing one or more selected from magnesium (Mg), titanium (Ti), zinc (Zn), manganese (Mn), iron (Fe), copper (Cu), and silicon (Si), and is preferably surface-coated with a metal having a large hydrogen overvoltage such as Zn or Sn. The thickness of the mesh negative electrode current collector is preferably 5 μm or more and 20 μm or less. The mesh negative electrode current collector having such a thickness can balance the strength and weight reduction of the electrode.

### (Positive Electrode)

A positive electrode may include a current collector (positive electrode current collector) and a positive electrode active material-containing layer provided on at least one surface of the current collector. The positive electrode active material-containing layer contains a positive electrode active material and optionally a conductive agent and a binder.

The positive electrode current collector includes metals such as stainless steel, aluminum (Al) and titanium (Ti). The positive electrode current collector has, for example, foil, porous body, or mesh shapes. The surface of the positive electrode current collector may be coated with a different kind of element in order to prevent corrosion due to the reaction between the positive electrode current collector and the aqueous electrolyte. The positive electrode current collector is preferably one having excellent corrosion resistance and oxidation resistance, such as Ti foil. Note that when Li₂SO₄ is used as the aqueous electrolyte, Al may be used as the positive electrode current collector because corrosion does not proceed.

The positive electrode current collector can include a portion on the surface of which the positive electrode active material-containing layer is not provided. This portion can act as a positive electrode current collecting tab.

The positive electrode active material-containing layer contains the positive electrode active material. The positive electrode active material-containing layer may be supported on both the front and back surfaces of the positive electrode current collector.

As the positive electrode active material, a compound having a lithium ion insertion-desorption potential of 2.5 V or more and 5.5 V or less (vs. Li/Li⁺) with respect to the lithium ion oxidation-reduction potential can be used. The positive electrode may contain one kind of compound alone as a positive electrode active material, or may contain two or more compounds as a positive electrode active material.

Examples of compounds that can be used as positive electrode active materials include lithium manganese composite oxide, lithium nickel composite oxide, lithium cobalt aluminum composite oxide, lithium nickel cobalt manganese composite oxide, and spinel type lithium manganese nickel composite oxide, lithium manganese cobalt composite oxide, lithium iron oxide, lithium fluorinated iron sulfate, a phosphate compound (for example, compounds represented by LiₖFePO₄ with 0<k≤1 and represented by LiₖMnPO₄ with 0<k≤1) having an olivine crystal structure, and the like. The phosphoric acid compound having the olivine crystal structure has excellent thermal stability.

Examples of compounds that can obtain a high positive electrode potential include: for example, lithium manganese composite oxides such as compounds having a spinel structure represented by LiₖMn₂O₄ with 0<k≤1 and compounds represented by Li MnO₂ with 0<k≤1; for example, a lithium nickel-aluminum composite oxide such as compounds represented by LiₖNi₁₋ᵢAlᵢO₂ with 0<k≤1, 0<i<1; for example, lithium cobalt composite oxides such as compounds represented by LiₖCoO₂ with 0<k≤1; for example, lithium nickel-cobalt composite oxides such as compounds represented by LiₖNi₁₋ᵢ₋ₜCoᵢMnₜO₂ with 0<k≤1, 0<i<1, and 0≤t<1; for example, lithium manganese cobalt composite oxides such as compounds represented by LiₖMnᵢCo₁₋ᵢO₂ with 0<k≤1 and 0<i<1; for example, spinel-type lithium manganese-nickel composite oxides such as compounds represented by LiₖMn₁₋ᵢNiᵢO₄ with 0<k≤1 and 0<i<1; for example, lithium phosphorylation having an olivine structure such as compounds represented by LiₖFePO₄ with 0<k≤1, compounds represented by LiₖFe_{1-y}Mn_{y}PO₄ with 0<k≤1 and 0≤y≤1, and compounds represented by LiₖCoPO₄ with 0<k≤1; and for example, fluorinated iron sulphate (for example, a compound represented by LiₖFeSO₄F with 0<k≤5 1).

The positive electrode active material preferably contains one or more selected from the group consisting of a lithium cobalt composite oxide, a lithium manganese composite oxide, and a lithium phosphorus oxide having an olivine structure. The working potential of these compounds is 3.5V (vs. Li/Li⁺) or more and 4.2V (vs. Li/Li⁺) or less. That is, the working potentials of these compounds as active materials are relatively high. A high battery voltage can be obtained by using these compounds in combination with the above-described negative electrode active materials such as spinel-type lithium titanate and anatase-type titanium oxide.

The positive electrode active material is contained in the positive electrode in the form of particles, for example. The positive electrode active material particles can be single primary particles, secondary particles that are aggregates of primary particles, or a mixture of the primary and secondary particles. The shape of the particles is not particularly limited, and can be, for example, spherical, elliptical, flat, fibrous, or the like.

The average particle size (diameter) of the primary particles of the positive electrode active material is preferably 10 μm or less, more preferably 0.1 μm or more and 5 μm or less. The average particle size (diameter) of the secondary particles of the positive electrode active material is preferably 100 μm or less, more preferably 10 μm or more and 50 μm or less. The primary particle size and the secondary particle size of the positive electrode active material can be measured in the same manner as the negative electrode active material particles.

The positive electrode active material-containing layer may contain a conductive agent, a binder, and the like in addition to the positive electrode active material. The conductive agent is added as necessary to improve the current collecting performance and suppress the contact resistance between the positive electrode active material and the current collector. Examples of the conductive agents include carbonaceous materials such as acetylene black, ketjen black, graphite, and coke. The conductive agent may be used alone or in combination of two or more.

Examples of the binders include polytetrafluoroethylene (PTFE), polyvinylidene fluoride (PVdF), fluororubber, ethylene-butadiene rubber, polypropylene (PP), polyethylene (PE), carboxymethyl cellulose (CMC), and polyimide (PI), polyacrylicimide (PAI), and the like. The binder may be one type or a mixture of two or more types. As the binder, polymer material contained in the composite layer, which will be described later, can also be used.

The compounding ratios of the positive electrode active material, the conductive agent, and the binder in the positive electrode active material-containing layer are preferably in the range of 70% by mass or more and 95% by mass or less, 3% by mass or more and 20% by mass or less, and 2% by mass or more and 10% by mass, respectively. When the compounding ratio of the conductive agent is 3% by mass or more, the conductivity of the positive electrode can be improved, and when the compounding ratio of the conductive agent is 20% by mass or less, the decomposition of the aqueous electrolyte on the surface of the conductive agent can be reduced. When the compounding ratio of the binder is 2% by mass or more, sufficient electrode strength can be obtained, and when the compounding ratio of the binder is 10% by mass or less, the insulating portion of the electrode can be reduced.

The positive electrode can be obtained, for example, by the following method. First, the positive electrode active material, the conductive agent, and the binder are suspended in a suitable solvent to prepare a slurry. This slurry is applied to one or both surfaces of the positive electrode current collector. The coating film on the positive electrode current collector is dried to form the positive electrode active material-containing layer. Thereafter, the positive electrode current collector and the positive electrode active material-containing layer formed on the positive electrode current collector are pressed. As the positive electrode active material-containing layer, a mixture of the positive electrode active material, the conductive agent, and the binder formed in pellet form may be used.

### (Composite Membrane)

A composite membrane includes a composite layer having a first surface that is joined to the negative electrode active material-containing layer and a second surface that is joined to the positive electrode active material-containing layer. The composite layer contains inorganic solid particles and a polymer material. The composite membrane functions as a separator in a secondary battery or an electrode group included in the secondary battery.

It is preferable that the denseness of the composite membrane is high and the water shielding property is high. In the electrode group including the composite membrane with high denseness and water shielding property, the combined body of the composite membrane and the negative electrode active material-containing layer, that is, the air permeability coefficient for the electrode structure is 1×10⁻¹⁹ m² or more and 1×10⁻¹⁵ m² or less. The calculation method of the air permeability coefficient of the electrode structure will be described later. When the air permeability coefficient is 1×10⁻¹⁹ m² or more and 1×10⁻¹⁵ m² or less, both water shielding property and ionic conductivity can be achieved. More preferably, the air permeability coefficient is 1×10⁻¹⁸ m² or more and 1×10⁻¹⁶ m² or less. Within this range, both water shielding property and ionic conductivity can be compatible.

The composite membrane can include a base material layer in addition to the composite layer. That is, the composite membrane may be a composite layer, and the composite membrane may include a composite layer and a base material layer. The base material layer may be provided between a composite layer (first composite layer) in contact with the surface of the negative electrode active material-containing layer and a composite layer (second composite layer) in contact with the surface of the positive electrode active material-containing layer. Unless otherwise specified, the first composite layer and the second composite layer are collectively referred to as the composite layer. The base material layer is made of, for example, a porous material described below and includes more pores than the composite layer. Therefore, the base material layer can retain more electrolytes than the composite layer. That is, the base material layer in contact with the composite layer is included in the composite membrane, and by configuring the arrangement in the order of the negative electrode active material-containing layer, the composite layer, the base material layer, the composite layer, and the positive electrode active material-containing layer, in the composite membrane, the amount of electrolyte retained in the base material layer away from the negative electrode can be increased, and the amount of electrolyte retained in the portion of the composite layer in contact with the negative electrode can be decreased. By including the base material layer in the composite membrane, the impregnation property of the electrolyte can be improved while maintaining the high denseness of the composite membrane.

Examples of the inorganic solid particles contained in the composite layer include oxide ceramics such as alumina, silica, zirconia, itria, magnesium oxide, calcium oxide, barium oxide, strontium oxide, and vanadium oxide, carbonates and sulfates such as sodium carbonate, potassium carbonate, magnesium carbonate, calcium carbonate, barium carbonate, lantern carbonate, cerium carbonate, calcium sulfate, magnesium sulfate, aluminum sulfate, gypsum, and barium sulfate, phosphates such as hydroxyapatite, lithium phosphate, zirconium phosphate, and titanium phosphate, nitride-based ceramics such as silicon nitride, titanium nitride, and boron nitride, and the like. The inorganic particles listed above may be in the form of hydrates.

The inorganic solid particles preferably contain solid electrolyte particles having an ionic conductivity of alkali metal ions. Specifically, the inorganic solid particles having an ionic conductivity for lithium ions and sodium ions are more preferable.

Examples of the inorganic solid particles having a lithium ionic conductivity include an oxide-based solid electrolyte and a sulfide-based solid electrolyte. As the oxide-based solid electrolyte, it is preferable to use a lithium phosphate solid electrolyte having a sodium (Na) super ionic conductor (NASICON) type structure and to use the lithium phosphate solid electrolyte represented by the general formula Li₁₊ₓM₂(PO₄)₃. M in the above general formula is one or more selected from the group consisting of, for example, titanium (Ti), germanium (Ge), strontium (Sr), zirconium (Zr), tin (Sn), aluminum (Al), and calcium (Ca). The subscript x is in the range 0≤x≤2. The ionic conductivity of the lithium phosphate solid electrolyte represented by the general formula LiM₂(PO₄)₃ is, for example, 1×10⁻⁵ S/cm or more and 1×10⁻³ S/cm or less.

A specific example of the lithium phosphate solid electrolyte having a NASICON type structure can include LATP compounds represented by Li_{1+w}Al_{w}Ti_{2-w}(PO₄)₃ with 0.1≤w≤0.5; compounds represented by Li_{1+y}Al_{z}M1_{2-z}(PO₄)₃, where M1 is one or more selected from the group consisting of Ti, Ge, Sr, Zr, Sn, and Ca, and 0≤y≤1 and 0≤z≤1; compounds represented by Li₁₊ₓAlₓGe₂₋ₓ(PO₄)₃ with 0≤x≤2; compounds represented by Li₁₊ₓAlₓZr₂₋ₓ(PO₄)₃ with 0≤x≤2; compounds represented by Li₁₊ᵤ₊ᵥAlᵤMα₂₋ᵤSiᵥP₃₋ᵥO₁₂, where Mα is one or more selected from the group consisting of Ti and Ge and 0<u≤2 and 0≤v<3; and compounds represented by Li₁₊₂ₜZr₁₋ₜCaₜ(PO₄)₃ with 0≤t<1. Li₁₊₂ₜZr₁₋ₜCaₜ(PO₄)₃ is preferably used as inorganic solid electrolyte particles due to high water resistance, low reducing property, and low cost.

In addition to the above lithium phosphate solid electrolyte, the oxide-based solid electrolyte can include: amorphous LIPON compounds represented by LiₚPO_{q}Nᵣ with 2.6≤p≤3.5, 1.9≤q≤3.8, and 0.1≤r≤1.3 (for example, Li_{2.9}PO_{3.3}N_{0.46}); compounds represented by La₅₊₃AₛLa₃₋ₛMβ₂O₁₂ having a garnet-type structure, where A is one or more selected from the group consisting of Ca, Sr, and Ba, and Mβ is one or more selected from the group consisting of Nb and Ta. 0≤s≤0.5; compounds represented by Li₃Mγ₂₋ₛL₂O₁₂, where Mγ is one or more selected from the group consisting of Ta and Nb, L can contain Zr, and 0≤s≤0.5; compounds represented by Li₇₋₃ₛAlₛLa₃Zr₃O₁₂ with 0≤s≤0.5; and an LLZ compounds represented by Li₅₊ₓLa₃M2₂₋ₓZrₓO₁₂ where M2 is one or more selected from the group consisting of Nb and Ta and 0≤x≤2 (for example, Li₇La₃Zr₂O₁₂). The solid electrolyte may be used alone or in combination of two or more. The ionic conductivity of LIPON is, for example, 1×10⁻⁶ S/cm or more and 5×10⁻⁶ S/cm or less. The ionic conductivity of LLZ is, for example, 1×10⁻⁴ S/cm or more and 5×10⁻⁴ S/cm or less.

Further, as the inorganic solid particles having an ionic conductivity of sodium ions, a sodium-containing solid electrolyte may be used. The sodium-containing solid electrolyte is excellent in the ionic conductivity of sodium ions. Examples of the sodium-containing solid electrolyte include β-alumina, sodium phosphorus sulfide, and sodium phosphorus oxide. The sodium ion-containing solid electrolyte is preferably in the form of glass-ceramics.

The inorganic solid particles are preferably solid electrolytes having a lithium ion conductivity of 1×10⁻⁵ S/cm or more at 25° C. Lithium ion conductivity can be measured, for example, by the AC impedance method. Details will be described later.

The shape of the inorganic solid particles is not particularly limited, but may be spherical, elliptical, flat, or fibrous, for example.

The average particle size of the inorganic solid particles is preferably 15 μm or less, and more preferably 12 μm or less. When the average particle size of inorganic solid particles is small, the denseness of the composite layer can be increased.

The average particle size of the inorganic solid particles is preferably 0.01 μm or more, and more preferably 0.1 μm or more. When the average particle size of the inorganic solid particles is large, the agglomeration of particles tends to be suppressed.

Note that the average particle size of the inorganic solid particles means the particle size at which the volume integration value is 50% in the particle size distribution obtained by the laser diffraction type particle size distribution measuring device. As a sample for this particle size distribution measurement, a dispersion diluted with ethanol is used so that the concentration of inorganic solid particles is 0.01% by mass to 5% by mass.

When the first composite layer and the second composite layer are provided on both the front and back surfaces of the base material layer, the inorganic solid particles contained in each composite layer may be the same as each other, but different types of particles may be used. Further, in the composite layer, the inorganic solid particles may be of a single type or may be a mixture of a plurality of types.

In the composite layer, the inorganic solid particles are preferably the main component. The ratio of the inorganic solid particles in the composite layer is preferably 70% by mass or more, more preferably 80% by mass or more, and further more preferably 85% by mass or more from the viewpoint of enhancing the ionic conductivity of the composite layer. The ratio of the inorganic solid particles in the composite layer is preferably 98% by mass or less, more preferably 95% by mass or less, and further more preferably 90% by mass or less from the viewpoint of increasing the film strength of the composite layer. The ratio of the inorganic solid particles in the composite layer can be calculated by thermogravimetric (TG) analysis.

The polymer material contained in the composite layer enhances the bondability between inorganic solid particles. A weight average molecular weight of the polymer material is, for example, 3000 or more. When the weight average molecular weight of the polymer material is 3000 or more, the binding property of the inorganic solid particles can be further increased. The weight average molecular weight of the polymer material is preferably 3000 or more and 5000000 or less, more preferably 5000 or more and 2000000 or less, and further more preferably 10000 or more and 1000000 or less. The weight average molecular weight of the polymer material can be determined by gel permeation chromatography (GPC).

The polymer material can be a polymer consisting of a single monomer unit, a copolymer consisting of a plurality of monomer units, or a mixture thereof. The polymer material preferably contains a monomer unit made of a hydrocarbon having a functional group containing one or more selected from the group consisting of oxygen (O), sulfur (S), nitrogen (N), and fluorine (F). In the polymer material, the ratio of the portion made of the monomer units is preferably 70 mol % or more. Hereinafter, this monomer unit will be referred to as a first monomer unit. Further, in the copolymer, those other than the first monomer unit are referred to as the second monomer unit. The copolymer of the first monomer unit and the second monomer unit may be an alternating copolymer, a random copolymer, or a block copolymer.

When the ratio occupied by the portion made of the first monomer unit in the polymer material is less than 70 mol %, the water shielding property of the first and second composite layers may decrease. In the polymer material, the ratio of the portion made of the first monomer units is preferably 90 mol % or more. In the polymer material, the ratio of the portion made of the first monomer unit is 100 mol %, that is, the polymer material is most preferably, a polymer composed only of the first monomer unit.

The first monomer unit may be a compound that has a functional group as a side chain containing one or more elements selected from the group consisting of oxygen (O), sulfur (S), nitrogen (N), and fluorine (F), and has a main chain constituted by a carbon-carbon bond. Hydrocarbons may have one or more functional groups containing one or more elements selected from the group consisting of oxygen (O), sulfur (S), nitrogen (N), and fluorine (F). The functional group in the first monomer unit increases the conductivity of alkali metal ions passing through the composite layer.

The hydrocarbon constituting the first monomer unit preferably has a functional group containing one or more selected from the group consisting of oxygen (O), sulfur (S), and nitrogen (N). When the first monomer unit has such a functional group, the conductivity of the alkali metal ions in the composite layer tends to be higher and the internal resistance tends to be lower.

The functional group contained in the first monomer unit preferably includes one or more selected from the group consisting of formal group, butyral group, carboxymethyl ester group, acetyl group, carbonyl group, hydroxyl group, and fluoro group. Further, the first monomer unit more preferably contains at least one of the carbonyl group and the hydroxyl group in the functional group, and still more preferably contains both thereof.

The first monomer unit can be represented by the following formula.

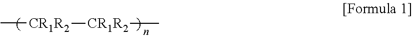

In the above formula, R1 is preferably selected from the group consisting of hydrogen (H), alkyl group, and amino group. In addition, R2 is preferably selected from the group consisting of hydroxyl group (—OH), —OR1, —COOR1, —OCOR1, —OCH(R1)O—, —CN, —N(R1)₃, and —SO₂R1.

Examples of the first monomer unit include one or more selected from the group consisting of vinyl formal, vinyl alcohol, vinyl acetate, vinyl acetal, vinyl butyral, acrylic acid and its derivatives, methacrylic acid and its derivatives, acrylonitrile, acrylamide and its derivatives, styrene sulfonic acid, and vinylidene polyfluoride, and tetrafluoroethylene.

The polymer material preferably contains one or more selected from the group consisting of polyvinyl formal, polyvinyl alcohol, polyvinyl acetal, polyvinyl butyral, methyl polymethacrylate, polyvinylidene fluoride, and polytetrafluoroethylene.

An example of the structural formula of a compound that can be used as a polymer material is described below.

The structural formula of polyvinyl formal is as follows. In the following formula, it is preferable that a is 50 or more and 80 or less, b is 0 or more and 5 or less, and c is 15 or more and 50 or less.

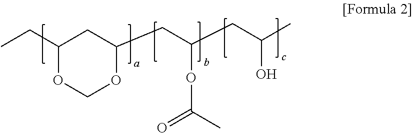

The structural formula of polyvinyl butyral is as follows. In the following formula, it is preferable that 1 is 50 or more and 80 or less, m is 0 or more and 10 or less, and n is 10 or more and 50 or less.

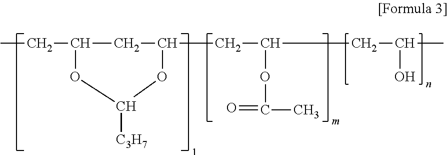

The structural formula of polyvinyl alcohol is as follows. In the following formula, n is preferably 70 or more and 20000 or less.

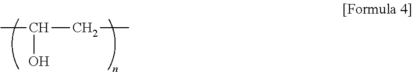

The structural formula of polymethyl methacrylate is as follows. In the following formula, n is preferably 30 or more and 10000 or less.

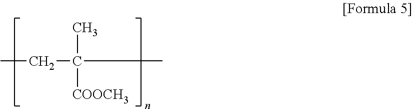

The second monomer unit is a compound other than the first monomer unit, that is, does not have a functional group containing one or more selected from the group consisting of oxygen (O), sulfur (S), nitrogen (N), and fluorine (F), or is one that is not hydrocarbon even if it has the functional group. Examples of the second monomer unit include ethylene oxide and styrene. Examples of the polymer made of the second monomer unit include polyethylene oxide (PEO) and polystyrene (PS).

The types of functional groups contained in the first monomer unit and the second monomer unit can be identified by Fourier transform infrared spectroscopy (FT-IR). Moreover, it can be determined by nuclear magnetic resonance (NMR) that the first monomer unit is made of hydrocarbon. In addition, the ratio occupied by the portion made of the first monomer unit in the copolymer of the first monomer unit and the second monomer unit can be calculated by the NMR.

The polymer material may contain an electrolyte. The ratio of the electrolyte that can be contained in the polymer material can be grasped from its water absorption rate. Here, the water absorption rate of the polymer material is a value by dividing a value obtained by subtracting a mass Mp of the polymer material before immersion from a mass Mp′ of the polymer material after immersion in water at a temperature of 23° C. for 24 hours by the mass Mp of the polymer material before immersion ([Mp′−Mp]/Mp×100). The water absorption rate of the polymer material is considered to be related to the polarity of the polymer material.

When a polymer material with a high water absorption rate is used, the alkali metal ionic conductivity of the composite layer tends to be increased. In addition, when the polymer material having the high water absorption rate is used, a binding force between the inorganic solid particles and the polymer material is increased, so the flexibility of the composite layer can be increased. The water absorption rate of the polymer material is preferably 0.01% or more, more preferably 0.5% or more, and still more preferably 2% or more.

The strength of the composite layer can be increased by using a polymer material with a low water absorption rate. That is, when the water absorption rate of the polymer material is too high, the composite layer may swell due to the electrolyte. Also, when the water absorption rate of the polymer material is too high, the polymer material in the composite layer may flow out into the electrolyte. The water absorption rate of the polymer material is preferably 15% or less, more preferably 10% or less, still more preferably 7% or less, and particularly preferably 3% or less.

The ratio of the polymer material in the composite layer is preferably 1% by mass or more, more preferably 3% by mass or more, and still more preferably 10% by mass or more from the viewpoint of increasing the flexibility of the composite layer. In addition, the higher the ratio of the polymer material, the higher the density of the composite layer tends to be.

The ratio of the polymer material in the composite layer is preferably 20% by mass or less, more preferably 10% by mass or less, and still more preferably 5% by mass or less from the viewpoint of enhancing the lithium ionic conductivity of the composite layer. The ratio of the polymer material in the composite layer can be calculated by thermogravimetric (TG) analysis.

When the first composite layer and the second composite layer are included, the polymer materials contained in each composite layer may be the same as each other or may be different types. Further, as the polymer material, a single type may be used, or a plurality of types may be mixed and used.

The polymer material of the first composite layer is the same as at least one kind of binder (polymer material) contained in the negative electrode active material-containing layer, but the polymer material of the second composite layer arranged on the positive electrode side may be the same as or different from at least one kind of binder (polymer material) contained in the negative electrode active material-containing layer.

The composite layer may contain a plasticizer or an electrolyte salt in addition to the inorganic solid particles and the polymer material. For example, when the composite layer contains an electrolyte salt, the alkali metal ionic conductivity of the composite membrane can be further increased.

The thickness of the composite layer is preferably 3 μm or more, more preferably 5 μm or more, and still more preferably 7 μm or more from the viewpoint that internal short circuits are unlikely to occur. In addition, the thickness of the composite layer is preferably 50 μm or less, more preferably 30 μm or less, and still more preferably 20 μm or less from the viewpoint of increasing the ionic conductivity and energy density.

When the first composite layer and the second composite layer are provided on both the front and back surfaces of the base material layer, the thicknesses of each composite layer may be the same as or different from each other. When the thicknesses are different, it is preferable that the first composite layer in contact with the first surface of the negative electrode active material-containing layer is thicker than the other second composite layer. Since the first composite layer is thicker, the water shielding property can be increased. Further, the composite layers provided on both the front and back sides of the base material layer may have the same configuration or different configurations.

The above thickness is preferable for each of the first composite layer and the second composite layer, but both composite layers do not necessarily have to be satisfied.

The base material layer can support a composite layer (first composite layer) on one surface thereof. Alternatively, the base material layer can support the first composite layer and the second composite layer on both surfaces thereof, respectively.

The base material layer is, for example, a non-woven fabric or a self-standing porous membrane. As a material for non-woven fabric or self-standing porous membrane, for example, polyethylene (PE), polypropylene (PP), cellulose, or polyvinylidene fluoride (PVdF) is used. The base material layer is preferably a non-woven fabric made of cellulose.

The base material layer can contain many pores and can be impregnated with a large amount of electrolyte. The base material layer typically does not contain the inorganic solid particles. For example, the ratio occupied by the area of the inorganic solid particles may be 5% or less in the cross section of the base material layer.

The thickness of the base material layer is, for example, 1 μm or more and preferably 3 μm or more. When the base material layer is thick, the mechanical strength of the composite membrane is increased, and the internal short circuit of the secondary battery is less likely to occur. The thickness of the base material layer is, for example, 30 μm or less and preferably 10 μm or less. When the base material layer is thin, the internal resistance of the secondary battery tends to decrease, and the volumetric energy density of the secondary battery tends to be increased. The thickness of the base material layer can be measured, for example, by a scanning electron microscope.

When the air permeability coefficient of the electrode structure is 1×10⁻¹⁸ m² or more and 1×10⁻¹⁶ m² or less and the density a is 95% or more, it is possible to appropriately suppress the aqueous electrolyte from being in contact with the negative electrode. When the air permeability coefficient is less than 1×10⁻¹⁵ m², a large amount of aqueous electrolyte passes through the composite layer even if the density a is set to 95%, so a large amount of negative electrode and aqueous electrolyte come into contact with each other and hydrogen is easily generated. When the air permeability coefficient exceeds 1×10⁻¹⁹ m², the aqueous electrolyte is not included in the composite layer itself, so that cation conduction is hindered and the cell resistance is increased too much.

Even if the air permeability coefficient of the electrode structure is in the range of 1×10⁻¹⁹ m² or more and 1×10⁻¹⁵ m² or less, when the density a is 80% or less, the composite layer is unable to be durable and have excellent electrolyte impregnation. This makes it easier for the electrolyte solvent to permeate on the surface side, and also makes it easier for dendrites such as lithium and zinc to break through. Furthermore, since the composite layer on the positive electrode active material-containing layer side has fewer voids, it becomes difficult to retain the aqueous electrolyte. Therefore, the impregnation property of the aqueous electrolyte is lowered, and the ionic conductivity is lowered.

As described above, the composite membrane may contain an electrolyte in the composite layer or the base material layer. The active material-containing layer can also further contain the electrolyte. That is, the electrode group may contain the first aqueous electrolyte in the negative electrode active material-containing layer, the second aqueous electrolyte in the composite membrane, and the third aqueous electrolyte in the positive electrode active material-containing layer. The first aqueous electrolyte, the second aqueous electrolyte, and the third aqueous electrolyte may have the same composition or may have different compositions. Hereinafter, unless otherwise specified, the first aqueous electrolyte, the second aqueous electrolyte, and the third aqueous electrolyte are collectively referred to simply as “aqueous electrolyte”. The aqueous electrolyte will be described later.

### <Manufacturing Method>

Next, a method of manufacturing an electrode group according to an embodiment will be described. In summary, the method of manufacturing an electrode group includes preparing a negative electrode active material-containing layer in which at least a part of the mesh negative electrode current collector is provided inside the negative electrode active material-containing layer, and applying a composite layer forming slurry to the surface of the negative electrode active material-containing layer to form a composite layer, thereby obtaining a joined body of the negative electrode and the composite membrane. In the following description, a case where an electrode group is produced using a composite membrane that does not include a base material layer will be described. Therefore, the composite layer is a composite membrane.

The method of forming a negative electrode active material-containing layer in which at least a part of the mesh negative electrode current collector is provided inside the negative electrode active material-containing layer is not particularly limited. For example, the process of immersing, dipping-coating, and drying the mesh negative electrode current collector in the negative electrode active material mixture slurry prepared by suspending the active material, the conductive agent, and the binder in an appropriate solvent is repeated plural times. Further, a method of obtaining a negative electrode active material-containing layer by pressing a coating film that has been applied until a desired basis weight is obtained, such as applying the same slurry thereto again, can be mentioned. In this way, the mesh negative electrode current collector can be embedded in the negative electrode active material-containing layer.

Next, the composite layer slurry is applied to the surface of the negative electrode active material-containing layer in which at least a part of the mesh negative electrode current collector is provided inside the negative electrode active material-containing layer to form a composite membrane, thereby obtaining the joined body of the composite membrane and the negative electrode, that is, an electrode structure.

The composite membrane including the composite layer is prepared as follows, for example.

The slurry for forming a composite layer is prepared. The slurry for forming a composite layer is obtained by stirring a mixture obtained by mixing the inorganic solid particles, the polymer material, and the solvent. The inorganic solid particles and the polymer material should be in the desired ratio when the composite membrane is measured.

It is preferable to use the solvent that can dissolve the polymer material. Examples of the solvent include alcohols such as ethanol, methanol, isopropyl alcohol, normal propyl alcohol, and benzyl alcohol; ketones such as acetone, methyl ethyl ketone, methyl isobutyl ketone, cyclohexanone, and diacetone alcohol; esters such as ethyl acetate, methyl acetate, butyl acetate, ethyl lactate, methyl lactate, and butyl lactate; ethers such as methyl cellosolve, ethyl cellosolve, butyl cellosolve, 1,4-dioxane, and tetrahydrofuran; glycols such as ethylene glycol monoethyl ether acetate, propylene glycol monomethyl ether acetate, butyl carbitol acetate, and ethyl carbitol acetate; glycol ethers such as methyl carbitol, ethyl carbitol, and butyl carbitol; aprotic polar solvents such as dimethylformamide, dimethylacetamide, acetonitrile, valeronitrile, N-methyl-2-pyrrolidone, N-ethyl-2-pyrrolidone, and γ-butyrolactam; cyclic carboxylic acid esters such as gamma-butyrolactone, gamma valerolactone, gamma caprolactone, and epsilon caprolactone; chain-like carbonate compounds such as dimethyl carbonate, diethyl carbonate, di-n-propyl carbonate, diisopropyl carbonate, n-propylisopropyl carbonate, ethylmethyl carbonate, and methyl-n-propyl carbonate.

A slurry for forming a composite layer is applied to a surface of a negative electrode active material-containing layer, for example, by a doctor blade method to obtain a coating film. This coating film is dried at a temperature of 50° C. or higher and 150° C. or lower. In this way, the coating film after drying obtains a laminate provided on the negative electrode active material-containing layer.

Next, this laminate is subjected to roll press processing. For the roll press processing, for example, a press device equipped with two rollers on the top and bottom is used. By using such a press device, the adhesion between the negative electrode active material-containing layer and the composite layer is increased. At this time, it is advisable to heat the roller in contact with the composite layer. The heating temperature of the rollers can be appropriately changed according to the desired structure. For example, the heating temperature of the roller shall be within the softening point ±20° C. of the polymer material in the coating film. By performing the roll press processing on the coating film at a temperature near the softening point of the polymer material, only the polymer material located on the surface side of the coating film is heated and softened. In addition, when the coating film is pressurized, the polymer material located in the coating film near the roll is plastically deformed. As a result, since the softened polymer material is located on the surface side of the coating film so as to fill the gap between the inorganic solid particles, the denseness is higher than that on the side in contact with the negative electrode active material-containing layer of the coating film. In this way, the composite layer having different denseness between the front side (positive electrode active material-containing layer side) and the inside (negative electrode active material-containing layer side) can be obtained. On the other hand, by performing the roll press processing on the coating film at room temperature of 25° C., the composite layer with uniform denseness can be obtained along the thickness direction of the coating film. The heating temperature of the rollers is preferably lower than the melting point of the polymer material. When the heating temperature is raised above the melting point of the polymer material, the polymer material melts on the surface side of the coating film, and pores can be completely lost. When pores are completely lost, the ionic conductivity of the composite layer is reduced, which is not preferable.

The softening point and melting point of the polymer material may vary depending on the molecular weight and the unit ratio of the monomer. According to one example, the softening point of PVdF is 135° C. or higher and 145° C. or lower, and the melting point is 170° C. or higher and 180° C. or lower. The softening point of polyvinyl formal is 120° C. or more and 130° C. or less, and the melting point is 190° C. or more and 200° C. or less. The softening point of polyvinyl butyral is 120° C. or higher and 130° C. or lower, and the melting point is 190° C. or higher and 200° C. or lower. Therefore, the heating temperature is appropriately adjusted according to the polymer material used. The softening point of the polymer material is preferably 100° C. or higher. That is, it is preferable that both the softening point of the first polymer material and the softening point of the second material are 100° C. or higher.

Alternatively, by applying two types of slurries so as to have a two-layer structure, a composite layer having different denseness on the front side and the inner side may be provided. That is, as a slurry for forming a lower layer having a low denseness, which is located on the negative electrode active material-containing layer side of the composite layer, for example, a slurry with a high ratio of inorganic solid particles and a low ratio of polymer material is prepared. This slurry for forming the lower layer is applied onto the surface of the negative electrode active material-containing layer and dried to obtain a coating film. Next, as a slurry for forming an upper layer having a high denseness, which is located on the surface side of the composite layer, for example, a slurry having a low ratio of inorganic solid particles and a high ratio of polymer material is prepared. This slurry for forming the upper layer is applied onto the coating film on one surface of the positive electrode active material-containing layer and dried to further provide a coating film. In this case, regardless of the heating temperature of the roller, a composite layer having different denseness between the front side (positive electrode active material-containing layer side) and the inside (negative electrode active material-containing layer side) can be obtained.

As described above, the joined body, that is, the electrode structure, in which the composite membrane and the negative electrode are bound to the composite layer, can be obtained.

This electrode structure is impregnated with the aqueous electrolyte, and then, the positive electrode prepared by applying the positive electrode active material mixture slurry to the positive electrode current collector and pressing is laminated on the composite layer side that is not bonded to the negative electrode active material-containing layer of this electrode structure, and are pressed, so the electrode group according to the present embodiment can be produced. The laminate of the electrode structure and the positive electrode may be a stack type electrode group produced by pressing the laminate, or may be a wound type electrode group produced by winding and pressing the laminate.

When the base material layer is provided in the composite membrane, the composite layer is provided in the negative electrode active material-containing layer as described above, and then the base material layer is provided on the composite layer. At this time, a material that does not interfere with the permeability of electrolyte is used. Then, the slurry for forming the composite layer is applied on the base material layer. When applying, the slurry for forming the composite layer is applied by the doctor blade method or the like, just as it was applied to the negative electrode active material-containing layer. Thereafter, the roll press is performed. As described above, the roll press appropriately changes the temperature according to the softening point temperature of the polymer material. After the roll press, the slurry for forming the positive electrode active material-containing layer can be applied to produce the electrode group in which the composite membrane contains a base material layer.

### <Measurement Method>

Various measurement methods will be described. When the electrode group to be measured is incorporated in the secondary battery, the secondary battery is discharged, and then is disassembled and takes out the electrode group.

### (Method of Measuring Peeling Strengths σ1 and σ2)

The peeling strength σ1 on the first surface and the peeling strength σ2 on the second surface in the electrode group can be measured by the surface/interface cutting method. Before measuring, both surfaces of the electrode group are rinsed with pure water, and then the electrode group is immersed in pure water and left for 48 hours or more. Thereafter, both surfaces are further rinsed with pure water and dried in a vacuum drying oven at 100° C. for hours or more to prepare a measurement sample of the electrode group.

The peeling strength can be measured by the surface/interface cutting method using a cutting strength measuring device such as Surface And Interfacial Cutting Analysis System (SAICAS) (registered trademark). Note that the surface/interface cutting method is sometimes called the SAICAS method. As the measuring device, for example, DN-GS manufactured by Daipla Wintes Co., Ltd. can be used. For the cutting edge, for example, a ceramic blade made of borazon material with a blade width of 1.0 mm is used. As the measurement conditions, for example, the blade angle is a rake angle of 20° and a burr angle of 10°.

In the measurement of the peeling strength σ1 on the first surface, first, the composite membrane is cut in a vertical direction with a pressing load of 1N (constant load mode). Here, by cutting at a constant speed of a horizontal speed of 2 μm/sec and a vertical speed of 0.2 μm/sec at a shear angle of 45° C., the blade is moved to a predetermined depth in the composite membrane. When the horizontal load (horizontal force) applied to the blade is decreased due to the composite layer peeling off from the negative electrode active material-containing layer, the vertical blade position is constantly maintained by controlling the vertical load to be 0.5N. Thereafter, the horizontal force (horizontal load) is measured at a horizontal speed of 2 μm/sec. After the horizontal force due to the peeling becomes constant, the measurement is continued over a 1 mm long region, and the average strength of the horizontal force measured in this length region is defined as the peeling strength σ1. In addition, the degree of uniformity of the peeling strength σ1 on the first surface can be confirmed from the profile measured in the 1 mm long area. In the profile, when the region where the deviation of the peeling strength σ1 from the average strength is 100% or more to the negative side is 10% or less, it can be determined that the electrode group in which the twisting of the composite membrane and the large liquid pool are unlikely to occur is obtained. Note that both the measurement temperature and the sample temperature shall be room temperature (25° C.)

Similarly, in the measurement of the peeling strength on the second surface, the positive electrode active material-containing layer is first cut in the vertical direction with the pressing load of 1 N (constant load mode). When the horizontal load (horizontal force) applied to the blade is decreased due to the positive electrode active material-containing layer peeling off from the current collector, the vertical blade position is constantly maintained by controlling the vertical load to be 0.5N. Thereafter, the horizontal force (horizontal load) is measured at a horizontal speed of 2 μm/sec. After the horizontal force due to the peeling becomes constant, the measurement is continued over a region of 1 mm length, and the average strength of the horizontal force measured in this length region is defined as the peeling strength σ2. Thereafter, the horizontal force (horizontal load) measured in the region where the horizontal force due to the peeling becomes constant is defined as the peeling strength σ2.

### (Method of Measuring Air Permeability Coefficient of Electrode Structure)

The air permeability coefficient (m²) of the electrode structure (joined body of the composite membrane and the negative electrode) is calculated as follows. In the calculation of the air permeability coefficient KT, for example, when an electrode structure having a thickness of L (m) is to be measured, a gas having a viscosity coefficient σ (Pa·s) is permeated within the measurement area A (m²). At this time, the gas is permeated under a plurality of conditions in which the pressure p (Pa) of the injected gas is different from each other, and the amount of gas Q (m³/s) permeated through the electrode structure is measured under each of the plurality of conditions. Then, from the measurement result, the gas amount Q with respect to the pressure p is plotted, and the slope dQ/dp is obtained. Then, from the thickness L, the measurement area A, the viscosity coefficient σ, and the slope dQ/dp, the air permeability coefficient KT is as shown in Equation (1).

KT=((σ·1)/A)×(dQ/dp) (1)

In an example of the calculation method of the air permeability coefficient KT, the electrode structure is sandwiched between a pair of stainless steel plates each having a hole with a diameter of 10 mm. Then, air is sent at pressure p from the hole of one of the stainless steel plates. Then, the gas amount Q of the air leaking from the hole of the other stainless steel plate is measured. Therefore, the area (25 πmm²) of the hole is used as the measurement area A, and 0.000018 Pa·s is used as the viscosity coefficient σ. The gas amount Q is calculated by measuring the amount δ (m³) leaking from the hole in 100 seconds and dividing the measured amount δ by 100.

Then, at four points where the pressure p is at least 1000 Pa away from each other, the gas amount Q with respect to the pressure p is measured as described above. For example, the gas amount Q with respect to the pressure p is measured at each of the four points where the pressure p is 1000 Pa, 2500 Pa, 4000 Pa, and 6000 Pa. Then, the gas amount Q with respect to the pressure p is plotted for the four measured points, and the slope (dQ/dp) of the gas amount Q with respect to the pressure p is calculated by linear fitting (least squares method). Then, the air permeability coefficient KT is calculated by multiplying the calculated slope (dQ/dp) by (σ·L)/A.

Note that in the measurement of the air permeability coefficient of the electrode structure, the electrode group is separated from the other parts of the battery. Both surfaces of the electrode group are washed with pure water, and then the electrode group is immersed in pure water and left for 48 hours or more. Thereafter, by further applying ultrasonic vibration, the positive electrode is peeled off, and the electrode structure, which is the joined body of the negative electrode/composite membrane, is taken out. Both surfaces of this electrode structure are rinsed with pure water, dried in a vacuum drying oven at 100° C. for 48 hours or more, and then the air permeability coefficient is measured. In addition, the air permeability coefficient is measured at any plurality of points in the electrode structure. Then, the value at the location where the air permeability coefficient becomes the lowest value among any plurality of places is defined as the air permeability coefficient of the electrode structure.

Since the negative electrode is coarser (rough) than the composite membrane even if the negative electrode active material-containing layer has the mesh negative electrode current collector, the air permeability coefficient reflects the properties of the composite membrane. In addition, for the composite membrane including the base material layer, the base material layer is coarser than the composite layer, so the air permeability coefficient reflects the properties of the composite layer. The higher the density of the base material layer, the lower the air permeability coefficient of the electrode structure tends to be.

### (Method of Measuring Lithium Ion Conductivity of Inorganic Solid Particles)

The measurement of lithium ion conductivity of inorganic solid particles by the AC impedance method will be described. First, the inorganic solid particles are molded using a tablet molding machine to obtain a green compact (pressurized powder body). Gold (Au) is deposited on both surfaces of this green compact to obtain a measurement sample. The AC impedance of the measurement sample is measured using an impedance measuring device. As the measuring device, for example, a frequency response analyzer 1260 manufactured by Solartron can be used. The measurement is performed in an argon atmosphere with a measurement frequency of 5 Hz to 32 MHz and a measurement temperature of 25° C.

Then, based on the measured AC impedance, a complex impedance plot is created. In the complex impedance plot, the horizontal axis is the real number component and the vertical axis is the imaginary number component. The ionic conductivity σLi of the inorganic solid particles is calculated by the following equation (2). In the following equation, ZLi is the resistance value calculated from the diameter of the arc of the complex impedance plot, S is the area, and d is the thickness.

σLi=(1/ZLi)×(d/S) (2)

According to according to the first embodiment, the electrode group includes a negative electrode that includes a negative electrode active material-containing layer and a mesh negative electrode current collector, at least a part of the mesh negative electrode current collector existing inside the negative electrode active material-containing layer, a positive electrode including the positive electrode active material-containing layer, and a separator that includes a composite membrane containing inorganic solid particles and a polymer material, wherein the composite membrane has a first surface joined to the negative electrode active material-containing layer and a second surface joined to the positive electrode active material-containing layer, at least one of a first polymer material constituting the negative electrode active material-containing layer is the same as a second polymer material constituting the composite membrane, a ratio a/b of a density a of 20° of the composite membrane from the second surface toward the first surface and a density b of 20% of the composite membrane from the first surface toward the second surface is greater than 1.05, a peeling strength σ1 of an interface between the composite membrane and the negative electrode active material-containing layer is greater than a peeling strength σ2 of the interface between the composite membrane and the positive electrode active material-containing layer, and an air permeability coefficient of a joined body of the composite membrane and the negative electrode is 1×10⁻¹⁹ m² or more and 1×10⁻¹⁵ m² or less. With such a configuration, it is possible to realize a secondary battery in which self-discharge is suppressed while exhibiting improved rate characteristics and high charge/discharge efficiency.

### Second Embodiment

According to the second embodiment, a secondary battery including the electrode group according to the first embodiment and the aqueous electrolyte is provided. The aqueous electrolyte contains water.

Further, the secondary battery according to the second embodiment may further include a container for accommodating an electrode group and an aqueous electrolyte.

Further, the secondary battery according to the second embodiment can further include a negative electrode terminal electrically connected to a negative electrode and a positive electrode terminal electrically connected to a positive electrode.

The secondary battery according to the second embodiment can be, for example, a lithium ion secondary battery. In addition, the secondary battery includes an aqueous electrolyte secondary battery containing an aqueous electrolyte.

The aqueous electrolyte can be retained in the electrode group. The aqueous electrolyte contains a first aqueous electrolyte retained by the electrode (negative electrode) in the electrode group and a second aqueous electrolyte retained by the composite membrane, and can further include a third aqueous electrolyte retained by the positive electrode.

Details of a third aqueous electrolyte are the same as those of the aqueous electrolyte (first aqueous electrolyte and second aqueous electrolyte) described in the first embodiment, and thus are omitted. The first aqueous electrolyte, the second aqueous electrolyte, and the third aqueous electrolyte may have the same composition or may have different compositions. Hereinafter, unless otherwise specified, the first aqueous electrolyte, the second aqueous electrolyte, and the third aqueous electrolyte are collectively referred to simply as “aqueous electrolyte”.

### (Aqueous Electrolyte)

The aqueous electrolyte contains an aqueous solvent and an electrolyte salt. The aqueous electrolyte is, for example, liquid. A liquid aqueous electrolyte is prepared by dissolving an electrolyte salt as a solute in an aqueous solvent.

As the electrolyte salt, for example, a lithium salt, a sodium salt, or a mixture thereof is used. One type or two or more types of electrolyte salts can be used.

Example of the lithium salts include lithium chloride (LiCl), lithium bromide (LiBr), lithium hydroxide (LiOH), lithium sulfate (Li₂SO₄), lithium nitrate (LiNO₃), lithium acetate (CH₃COOLi), lithium oxalate (Li₂C₂O₄), lithium carbonate (Li₂CO₃), lithium bis (trifluoromethanesulfonyl) imide) (LiTPSI; LiN(SO₂CF₃)₂), lithium bis (fluorosulfonyl) imide (LiPSI; LiN(SO₂F)₂), and Lithium bisoxalate borate (LiBOB; LiB[(OCO)₂]₂), and the like.

Examples of the sodium salt include sodium chloride (NaCl), sodium sulfate (Na₂SO₄), sodium hydroxide (NaOH), sodium nitrate (NaNO₃), sodium trifluoromethanesulfonylamide (NaTPSA), and the like.

The lithium salt preferably contains LiCl. LiCl can be used to increase the lithium ion concentration of aqueous electrolyte. The lithium salt preferably contains at least one of LiSO₄ and LiOH in addition to LiCl.

In addition to the lithium salt, a zinc salt such as zinc chloride or zinc sulfate may be added to an electrolytic solution. By adding such a compound to the electrolytic solution, a zinc-containing coating layer and/or an oxidized zinc-containing region can be formed on the electrode in a battery using the electrode included in the electrode group as a negative electrode. These zinc-containing members exert an effect of suppressing hydrogen generation in the electrodes on which they are formed.

The molar concentration of lithium ions in the aqueous electrolyte is preferably 3 mol/L or more, preferably 6 mol/L or more, and preferably 12 mol/L or more. When the concentration of lithium ions in the aqueous electrolyte is high, the electrolysis of the aqueous solvent at the electrode tends to be suppressed, and hydrogen generation from the electrode tends to be small.

In the aqueous electrolyte, the amount of aqueous solvent is preferably 1 mol or more with respect to 1 mol of the salt to be the solute. A more preferable form is that the amount of aqueous solvent per 1 mol of the salt as a solute is 3.5 mol or more. The aqueous solvent contains, for example, water in a proportion of 50% by volume or more.

The aqueous electrolyte may preferably contain one or more selected from the group consisting of chloride ion (Cl⁻), hydroxide ion (OH⁻), sulfate ion (SO₄²⁻), and nitrate ion (NO³⁻) as anion species.

The pH of the aqueous electrolyte is preferably 3 or more and 14 or less, and more preferably 4 or more and 13 or less. In each embodiment, the pH was measured at 25±2° C.

The pH of the aqueous electrolyte is preferably different between negative electrode side and positive electrode side after the initial charging. In the secondary battery after the initial charging, the pH of the first aqueous electrolyte of the negative electrode side is preferably 3 or more, more preferably 5 or more, and still more preferably 7 or more. Further, in the secondary battery after the initial charging, the pH of the third aqueous electrolyte of the positive electrode side is preferably in the range of 0 or more and 7 or less, and more preferably in the range of 0 or more and 6 or less.

The pH of the aqueous electrolyte on the negative electrode side and the positive electrode side can be obtained, for example, by disassembling the secondary battery and measuring the pH of the aqueous electrolyte existing between the separator and the negative electrode and the positive electrode, respectively.

As the aqueous solvent, a solution containing water can be used. The solution containing water may be pure water or a mixed solvent of water and an organic solvent.

The aqueous electrolyte may be a gel-like electrolyte. The gel-like electrolyte is prepared by mixing and compounding the above-described liquid aqueous electrolyte and polymer compound. Examples of the polymer compound include polyvinylidene fluoride (PVdF), polyacrylonitrile (PAN), polyethylene oxide (PEO), and the like.

The inclusion of water in the aqueous electrolyte can be confirmed by Gas Chromatography-MaNS Spectrometry (GC-MS) measurement. In addition, the salt concentration and water content in the aqueous electrolyte can be measured by, for example, inductively coupled plasma (ICP) luminescence analysis. The molar concentration (mol/L) can be calculated by weighing the aqueous electrolyte in a specified amount and calculating the concentration of the salt contained. In addition, the number of moles of solute and solvent can be calculated by measuring the specific gravity of aqueous electrolyte.

### (Method of Measuring pH of Aqueous Electrolyte)

The method of measuring pH of an aqueous electrolyte is as follows.

The electrodes of the electrode group taken out by disassembling the secondary battery and the electrolyte contained in the electrode of the electrode group and the composite membrane are respectively extracted, and after measuring the amount of liquid, the pH value is measured with a pH meter. The pH measurement is performed as follows, for example. For this measurement, for example, F-74 manufactured by HORIBA, Ltd. is used, and the measurement is performed in an environment of 25±2° C. First, standard solutions of pH 4.0, 7.0, and 9.0 are prepared. Next, calibration of F-74 is performed using these standard solutions. An appropriate amount of the electrolyte (electrolytic solution) to be measured is prepared in a container and the pH of the electrolyte is measured. After measuring the pH, the sensor part of F-74 is cleaned. When measuring another measurement target, the above-described procedure, that is, calibration, measurement, and cleaning is performed each time.

### <Outer Layer Member>

A metal container, a laminate film container, or a resin container can be used as the outer layer member in which the electrode group and the aqueous electrolyte are housed.

As the metal container, a metal can made of nickel, iron, stainless steel, and the like, which has a square or cylindrical shape, can be used. As the resin container, one made of polyethylene, polypropylene, or the like can be used.

The thickness of each of the resin container and the metal container is preferably in the range of 0.05 mm or more and 1 mm or less. The plate thickness is more preferably 0.5 mm or less, and still more preferably 0.3 mm or less.

Examples of the laminated film include a multilayer film in which a metal layer is coated with a resin layer. Examples of metal layers include a stainless steel foil, an aluminum foil, and an aluminum alloy foil. As the resin layer, polymers such as polypropylene (PP), polyethylene (PE), nylon, and polyethylene terephthalate (PET) can be used. The thickness of the laminated film is preferably in the range of 0.01 mm or more and 0.5 mm or less. The thickness of the laminated film is more preferably 0.2 mm or less.

The secondary battery can be used in various forms such as square, cylindrical, flat, thin, and coin shapes. Further, the secondary battery may be a secondary battery having a bipolar structure. A secondary battery having a bipolar structure has an advantage that a plurality of series cells can be produced by one cell.

### <Terminal>

The negative electrode terminal can be made of a material that is electrochemically stable and conductive in the potential range (vs. Li/Li⁺) of 1 V or more and 3 V or less with respect to the oxidation-reduction potential of lithium. Specifically, examples of the material of the negative electrode terminal include zinc, copper, nickel, stainless steel, or aluminum, or aluminum alloys containing at least one selected from the group consisting of Mg, Ti, Zn, Mn, Fe, Cu, and Si. It is preferable to use zinc or a zinc alloy as the material of the negative electrode terminal. The negative electrode terminal is preferably made of the same material as the negative electrode current collector in order to reduce the contact resistance with the negative electrode current collector (for example, the current collector contained in the negative electrode structure).

The positive electrode terminal can be made of a material that is electrically stable and conductive in the potential range (vs. Li/Li⁺) of 2.5 V or more and 4.5 V or less with respect to the oxidation-reduction potential of lithium. Examples of the material of the positive electrode terminal include titanium, aluminum, or an aluminum alloy containing at least one element selected from the group consisting of Mg, Ti, Zn, Mn, Fe, Cu, and Si. The positive electrode terminal is preferably made of the same material as the positive electrode current collector in order to reduce the contact resistance with the positive electrode current collector.

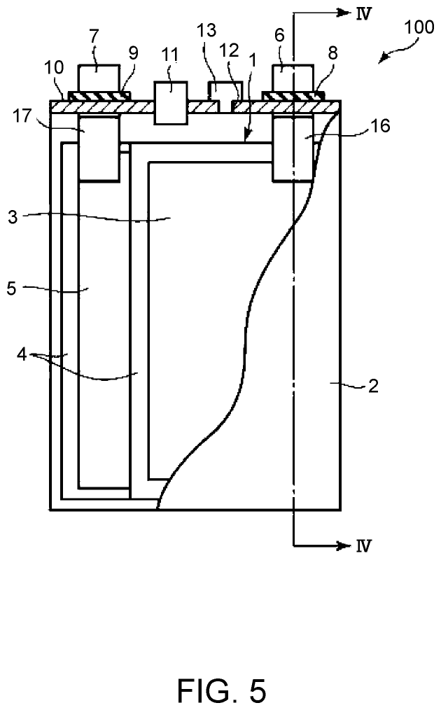

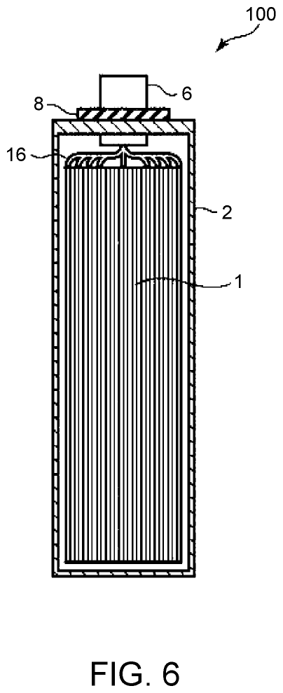

Hereinafter, the details of the secondary battery according to the embodiment will be described with reference to FIGS. 5 and 6. FIG. 5 is a cross-sectional view schematically illustrating an example of the secondary battery according to the embodiment. FIG. 6 is a cross-sectional view of the secondary battery illustrated in FIG. 5 along the line IV-IV line.

The electrode group 1 is housed in an exterior member made of a rectangular tubular metal container. The electrode group 1 includes a negative electrode 3, a composite membrane 4, and a positive electrode 5. The electrode group 1 has a structure in which the positive electrode 5 and the negative electrode 3 are arranged so that the composite membrane 4 as the separator is interposed and wound in a spiral shape so as to have a flat shape. The aqueous electrolyte (not illustrated) is retained in the electrode group 1. As illustrated in FIG. 5, a strip-shaped negative electrode current collecting tab 16 is electrically connected to each of the plurality of ends of the negative electrode 3 located on the end face of the electrode group 1. In addition, a strip-shaped positive electrode current collecting tab 17 is electrically connected to each of a plurality of locations at the end of the positive electrode 5 located on this end face. As illustrated in FIG. 6, the plurality of negative electrode current collecting tabs 16 are connected to the negative electrode terminal 6 in a bundled state. In addition, although not illustrated, the positive electrode current collecting tab 17 is also electrically connected to the positive electrode terminal 7 in a bundled state.

A metal sealing plate 10 is fixed to an opening of the metal exterior member 2 by welding or the like. The negative electrode terminal 6 and the positive electrode terminal 7 are each drawn out from the take-out holes provided in the sealing plate 10. A negative electrode gasket 8 and a positive electrode gasket 9 are arranged on an inner peripheral surface of each take-out hole of the sealing plate 10 in order to avoid a short circuit due to contact with the negative electrode terminal 6 and the positive electrode terminal 7, respectively. By arranging the negative electrode gasket 8 and the positive electrode gasket 9, the airtightness of the secondary battery 100 can be maintained.

A control valve 11 (safety valve) is arranged on the sealing plate 10. When the internal pressure in the battery cell increases due to the gas generated by the electrolysis of the aqueous solvent, the generated gas can be released to the outside from the control valve 11. As the control valve 11, for example, a return type that operates when the internal pressure becomes higher than the set value and functions as a sealing plug when the internal pressure drops can be used. Alternatively, a non-returnable control valve that does not recover its function as a sealing plug once activated may be used. In FIG. 5, the control valve 11 is located in the center of the sealing plate 10, but the position of the control valve 11 may be the end of the sealing plate 10. The control valve 11 may be omitted.

In addition, the sealing plate 10 is provided with a liquid injection port 12. The aqueous electrolyte can be injected through this liquid injection port 12. The liquid injection port 12 can be blocked by the sealing plug 13 after the aqueous electrolyte has been injected. The liquid injection port 12 and the sealing plug 13 may be omitted.

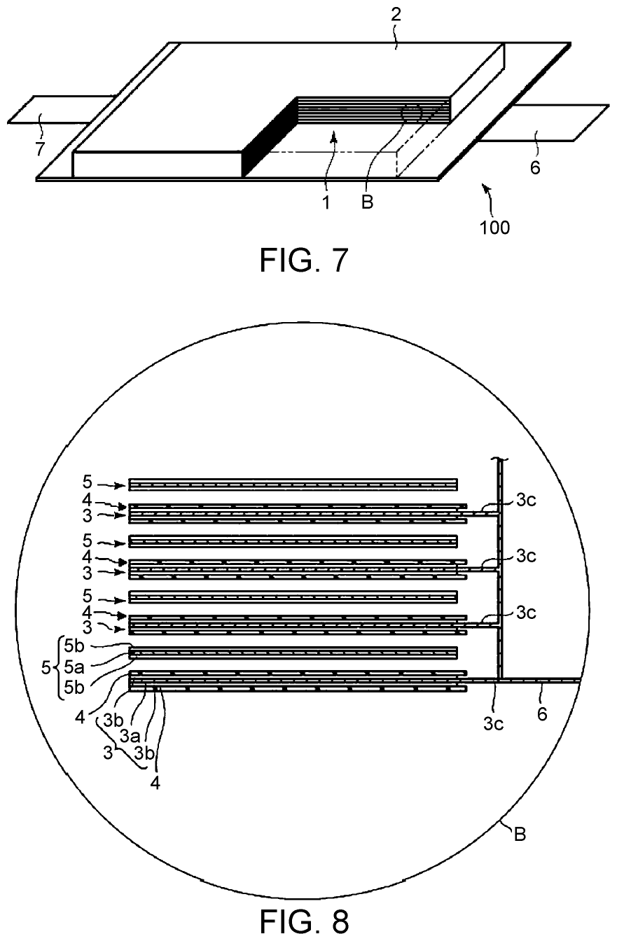

FIG. 7 is a partially cut perspective view schematically illustrating another example of the secondary battery according to the embodiment. FIG. 8 is an enlarged cross-sectional view of part B of the secondary battery illustrated in FIG. 7. FIGS. 7 and 8 illustrate an example of secondary battery 100 using an exterior member made of a laminated film as a container.

The secondary battery 100 illustrated in FIGS. 7 and 8 includes the electrode group 1 illustrated in FIGS. 7 and 8, the exterior member 2 illustrated in FIG. 7, and the aqueous electrolyte (not illustrated). The electrode group and the aqueous electrolyte are housed in the exterior member 2. The aqueous electrolyte is retained in electrode group 1.

The exterior member 2 is made of a laminated film that includes two resin layers and a metal layer interposed therebetween.

As illustrated in FIG. 8, the electrode group 1 is a laminated electrode group. The laminated electrode group 1 has plural sets of negative electrode 3, the composite membrane 4, and the positive electrode 5, and has a structure in which they are laminated in this order.

Each negative electrode 3 has a negative electrode current collector 3a and a negative electrode active material-containing layer 3b arranged on both surfaces of the negative electrode current collector 3a. Each composite membrane 4 is supported on the negative electrode active material-containing layer 3b of the negative electrode 3. In addition, the electrode group 1 includes a plurality of positive electrodes 5. Each of the plurality of positive electrodes 5 has a positive electrode current collector 5a and a positive electrode active material-containing layer 5b supported on both surfaces of the positive electrode current collector 5a. The positive electrode 5 and the composite layer 4 are drawn separately because the figure becomes complicated, but as described above, the negative electrode 3 and the positive electrode of the electrode group 1 are in contact with the composite membrane 4, respectively.

The negative electrode current collector 3a of each negative electrode 3 includes a portion 3c on one side thereof in which no negative electrode active material-containing layer 3b is provided on any surface. This portion 3c acts as a negative electrode current collecting tab. As illustrated in FIG. 8, the portion 3c that acts as a negative electrode current collecting tab does not overlap with the positive electrode 5. In addition, a plurality of negative electrode current collecting tabs (portion 3c) are electrically connected to the strip-shaped negative electrode terminal 6. The tip of the strip-shaped negative electrode terminal 6 is drawn out to the outside of the exterior member 2.

In addition, although not illustrated, the positive electrode current collector 5a of each positive electrode 5 includes a portion on one side thereof in which the positive electrode active material-containing layer 5b is not supported on any surface. This portion act as a positive electrode current collecting tab. Like the negative electrode current collecting tab (portion 3c), the positive electrode current collecting tab does not overlap with the negative electrode 3. Also, the positive electrode current collecting tab is located on the opposite side of electrode group 1 with respect to the negative electrode current collecting tab (portion 3c). The positive electrode current collecting tab is electrically connected to the strip-shaped positive electrode terminal 7. The tip of the strip-shaped positive electrode terminal 7 is located on the opposite side of the negative electrode terminal 6, and is drawn out to the outside of the exterior member 2.

The secondary battery according to the second embodiment includes the electrode group according to the first embodiment. Therefore, the secondary battery exhibits the high charge/discharge efficiency, the improved rate characteristics, and the suppressed self-discharge.

### Third Embodiment

According to the third embodiment, an assembled battery is provided. The assembled battery includes a plurality of secondary batteries according to the second embodiment.

In the assembled battery according to the embodiment, each cell may be electrically connected in series or in parallel, or may be arranged in combination with a series connection and a parallel connection.

Next, an example of the assembled battery will be described with reference to the drawings.

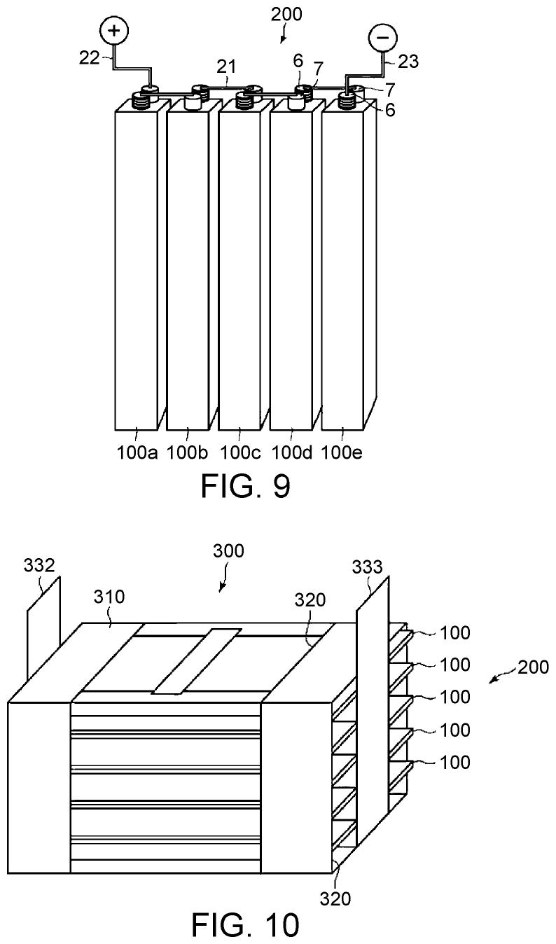

FIG. 9 is a perspective view schematically illustrating an example of the assembled battery according to the embodiment. The assembled battery 200 illustrated in FIG. 9 is equipped with five unit cells 100a to 100e, four bus bars 21, a positive electrode side lead 22, and a negative electrode side lead 23. Each of the five unit cells 100a to 100e is a secondary battery according to the second embodiment.

The bus bar 21 connects, for example, the negative electrode terminal 6 of one cell 100a and the positive electrode terminal 7 of the adjacent cell 100b. In this way, the five unit cells 100 are connected in series by four bus bars 21. That is, the assembled battery 200 in FIG. 9 is a 5-series assembled battery. Although not illustrated in the example, in an assembled battery containing a plurality of cells electrically connected in parallel, for example, a plurality of negative electrode terminals are connected to each other by a bus bar and a plurality of positive electrode terminals are connected to each other by a bus bar, so a plurality of unit cells can be electrically connected.

The positive electrode terminal 7 of at least one of the five unit cells 100a to 100e is electrically connected to the positive electrode side lead 22 for external connection. In addition, the negative electrode terminal 6 of at least one of the five unit cells 100a to 100e is electrically connected to the negative electrode side lead 23 for external connection.

The assembled battery according to the embodiment includes the secondary battery according to the embodiment. Therefore, the assembled battery can exhibit the high charge/discharge efficiency, the improved rate characteristics, and the suppressed self-discharge.

### Fourth Embodiment

According to a fourth embodiment, a battery pack including the secondary battery according to the second embodiment is provided. The battery pack can include the assembled battery according to the third embodiment. The battery pack may include a single secondary battery according to the second embodiment instead of the assembled battery according to the third embodiment.

Such a battery pack may further include a protection circuit. The protection circuit has a function of controlling the charging and discharging of the secondary battery. Alternatively, circuits included in devices (for example, an electronic device, an automobile, and the like) that use the battery pack as a power supply may be used as the protection circuit of the battery pack.

The battery pack can further include an external terminal for energization. The external terminal for energization is for outputting the current from the secondary battery to the outside and/or for inputting a current from the outside to the secondary battery. In other words, when using the battery pack as the power supply, a current is supplied to the outside through the external terminal for energization. Also, when charging the battery pack, the charging current (including the regenerative energy of the power of the automobile and the like) is supplied to the battery pack through the external terminal for energization.

Next, an example of the battery pack according to the embodiment will be described with reference to the drawings.

FIG. 10 is a perspective view schematically illustrating an example of the battery pack according to the embodiment.

The battery pack 300 includes, for example, an assembled battery including a secondary battery illustrated in FIGS. 7 and 8. The battery pack 300 includes a housing 310 and assembled battery 200 housed in the housing 310. The assembled battery 200 is a combination of a plurality (for example, 5) of secondary batteries 100 electrically connected in series. The secondary battery 100 is stacked in the thickness direction. The housing 310 has openings 320 on an upper portion and on each of the four sides. The protruding sides of the negative electrode terminal 6 and the positive electrode terminal 7 of the secondary battery 100 are exposed in the opening 320 of the housing 310. The positive electrode terminal 332 for output of the assembled battery 200 has a band shape, one end is electrically connected to one of the positive electrode terminals 7 of the secondary battery 100, and the other end protrudes from the opening 320 of the housing 310 and protrudes from the upper portion of the housing 310. Meanwhile, the negative electrode terminal 333 for output of the assembled battery 200 has a band shape, one end is electrically connected to one of the negative electrode terminals 6 of the secondary battery 100, and the other end protrudes from the opening 320 of the housing 310 and protrudes from the upper portion of the housing 310.

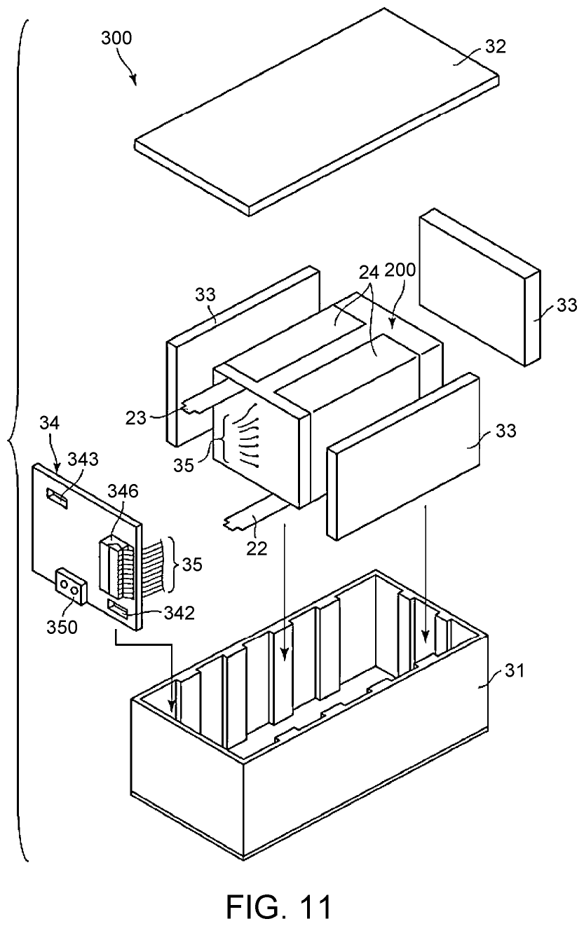

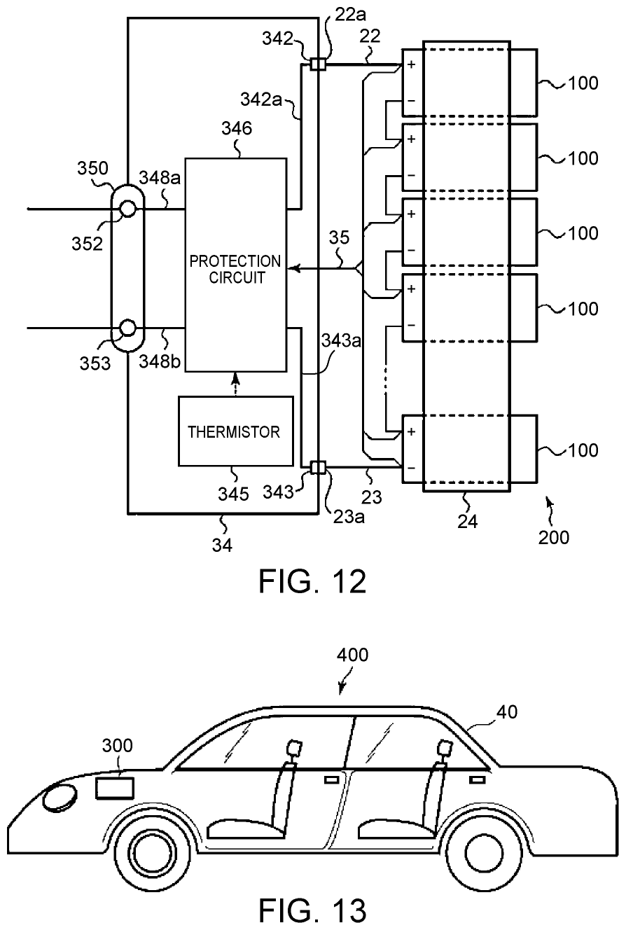

Another example of such a battery pack will be described in detail with reference to FIGS. 11 and 12. FIG. 11 is an exploded perspective view schematically illustrating another example of the battery pack according to the embodiment. FIG. 12 is a block diagram illustrating an example of an electric circuit of the battery pack illustrated in FIG. 11.

The battery pack 300 illustrated in FIGS. 11 and 12 includes a housing container 31, a lid 32, a protective sheet 33, the assembled battery 200, a print circuit board 34, a wiring 35, and an insulating plate (not illustrated).

The housing container 31 illustrated in FIG. 11 is a bottomed square container with a rectangular bottom surface. The housing container 31 is configured to accommodate the protective sheet 33, the assembled battery 200, the print circuit board 34, and the wiring 35. The lid 32 has a rectangular shape. The lid 32 covers the housing container 31 to accommodate the assembled battery 200 and the like. Although not illustrated, the housing container 31 and the lid 32 are provided with an opening, a connection terminal, or the like for connecting to an external device or the like.

The assembled battery 200 has a plurality of unit cells 100, a positive electrode side lead 22, a negative electrode side lead 23, and an adhesive tape 24.

At least one of the plurality of unit cells 100 is a secondary battery according to the embodiment. Each of the plurality of unit cells 100 is electrically connected in series as illustrated in FIG. 12. The plurality of unit cells 100 may be electrically connected in parallel or electrically connected in combination of series and parallel connections. When the plurality of unit cells 100 are connected in parallel, the battery capacity increases compared to when they are connected in series.

The adhesive tape 24 connects the plurality of unit cells 100. The plurality of unit cells 100 may be fixed using a heat shrink tape instead of the adhesive tape 24. In this case, the protective sheets 33 are disposed on both side surfaces of the assembled battery 200, and after the heat-shrinkable tape is circulated, the heat-shrinkable tape is heat-shrunken to bind the plurality of unit cells 100.

One end of the positive electrode side lead 22 is connected to the assembled battery 200. One end of the positive electrode side lead 22 is electrically connected to the positive electrodes of one or more unit cells 100. One end of the negative electrode side lead 23 is connected to the assembled battery 200. One end of the negative electrode side lead 23 is electrically connected to the negative electrodes of one or more unit cells 100.

The print circuit board 34 is installed along one of the inner side surfaces of the housing container 31 in the direction of the short side. The print circuit board 34 includes a positive electrode side connector 342, a negative electrode side connector 343, a thermistor 345, a protection circuit 346, wirings 342a and 343a, an external terminal for energization 350, a plus side wiring (positive side wiring) 348a, and a minus side wiring (negative side wiring) 348b. One side of the print circuit board 34 faces one side of the assembled battery 200. An insulating plate (not shown) is interposed between the print circuit board 34 and the assembled battery 200.

The other end 22a of the positive electrode side lead 22 is electrically connected to the positive electrode side connector 342. The other end 23a of the negative electrode side lead 23 is electrically connected to the negative electrode side connector 343.

The thermistor 345 is fixed to one side of the print circuit board 34. The thermistor 345 detects the temperature of each unit cell 100 and transmits the detection signal to the protection circuit 346.

The external terminal for energization 350 is fixed to the other side of the print circuit board 34. The external terminal for energization 350 is electrically connected to equipment located outside the battery pack 300. The external terminal for energization 350 includes a positive side terminal 352 and a negative side terminal 353.

The protection circuit 346 is fixed to the other side of the print circuit board 34. The protection circuit 346 is connected to the positive side terminal 352 via the plus side wiring 348a. The protection circuit 346 is connected to the negative side terminal 353 via the minus side wiring 348b. In addition, the protection circuit 346 is electrically connected to the positive electrode side connector 342 via the wiring 342a. The protection circuit 346 is electrically connected to the negative electrode side connector 343 via the wiring 343a. In addition, the protection circuit 346 is electrically connected to each of the plurality of unit cells 100 via the wiring 35.

The protective sheet 33 is arranged on both the inner side surface of the housing container 31 in the long side direction and on the inner side surface in the short side direction facing the print circuit board 34 via the assembled battery 200. The protective sheet 33 is made of, for example, resin or rubber.

The protection circuit 346 controls the charging and discharging of the plurality of unit cells 100. In addition, the protection circuit 346 cuts off the electrical connection between the protection circuit 346 and the external terminal for energization 350 (positive side terminal 352 and negative side terminal 353) to the external device based on the detection signal transmitted from the thermistor 345 or the detection signal transmitted from the individual unit cell 100 or the assembled battery 200.

Examples of the detection signal transmitted from the thermistor 345 include a signal that detects that the temperature of the unit cell 100 is equal to or higher than a predetermined temperature. Examples of the detection signal transmitted from the individual unit cell 100 or the assembled battery 200 include signals for detecting overcharge, overdischarge, and overcurrent of the unit cell 100. When detecting overcharge or the like for each unit cell 100, the battery voltage may be detected, or the positive electrode potential or the negative electrode potential may be detected. In the latter case, a lithium electrode used as a reference electrode is inserted into each unit cell 100.

Note that as the protection circuit 346, a circuit included in a device (for example, an electronic device, an automobile, or the like) that uses the battery pack 300 as the power supply may be used.

In addition, this battery pack 300 includes the external terminal for energization 350 as described above. Therefore, this battery pack 300 can output the current from the assembled battery 200 to the external device and input the current from the external device to the assembled battery 200 via the external terminal for energization 350. In other words, when using the battery pack 300 as the power supply, the current from the assembled battery 200 is supplied to the external device via the external terminal for energization 350. In addition, when charging the battery pack 300, the charging current from the external device is supplied to the battery pack 300 via the external terminal for energization 350. When this battery pack 300 is used as an in-vehicle battery, the regenerative energy of the vehicle power can be used as the charging current from the external device.

Note that the battery pack 300 may include the plurality of assembled batteries 200. In this case, the plurality of assembled batteries 200 may be connected in series, connected in parallel, or connected in combination of series and parallel connections. Also, the print circuit board 34 and the wiring 35 may be omitted. In this case, the positive electrode side lead 22 and the negative electrode side lead 23 may be used as the positive side terminal and the negative side terminal of the external terminal for energization, respectively.

Such a battery pack is used, for example, in applications where excellent cycle performance is required when a large current is taken out. Specifically, this battery pack is used, for example, as the power supply for the electronic device, a stationary battery, and an in-vehicle battery for various vehicles. Examples of the electronic device include a digital camera. This battery pack is particularly preferably used as an in-vehicle battery.

The battery pack according to the fourth embodiment includes the secondary battery according to the second embodiment or the assembled battery according to the third embodiment. Therefore, the battery pack exhibits the high charge/discharge efficiency, the improved rate characteristics, and the suppressed self-discharge.

### Fifth Embodiment

According to a fifth embodiment, a vehicle including the battery pack according to the fourth embodiment is provided.

In such a vehicle, the battery pack recovers, for example, regenerative energy of vehicle's power. The vehicle may include a mechanism (regenerator) that converts kinetic energy of this vehicle into the regenerative energy.

Examples of the vehicle according to the embodiment include a two-wheel to four-wheel hybrid electric vehicle, a two-wheel to four-wheel electric vehicle, an assisted bicycle, and a railroad vehicle.

The mounting position of the battery pack in the vehicle according to the embodiment is not particularly limited. For example, when the battery pack is mounted in a vehicle, the battery pack can be mounted in an engine room of the vehicle, behind a vehicle body or under a seat.

The vehicle according to the embodiment may be equipped with a plurality of battery packs. In this case, batteries included in each battery pack may be electrically connected in series, electrically connected in parallel, or electrically connected by combining series connection and parallel connection. For example, when each battery pack includes an assembled battery, the assembled batteries may be electrically connected in series, electrically connected in parallel, and electrically connected in a combination of series and parallel connections. Alternatively, when each battery pack includes a single battery, the batteries may be electrically connected in series, electrically connected in parallel, or electrically connected in a combination of series and parallel connections.

Next, an example of the vehicle according to the embodiment will be described with reference to the drawings.

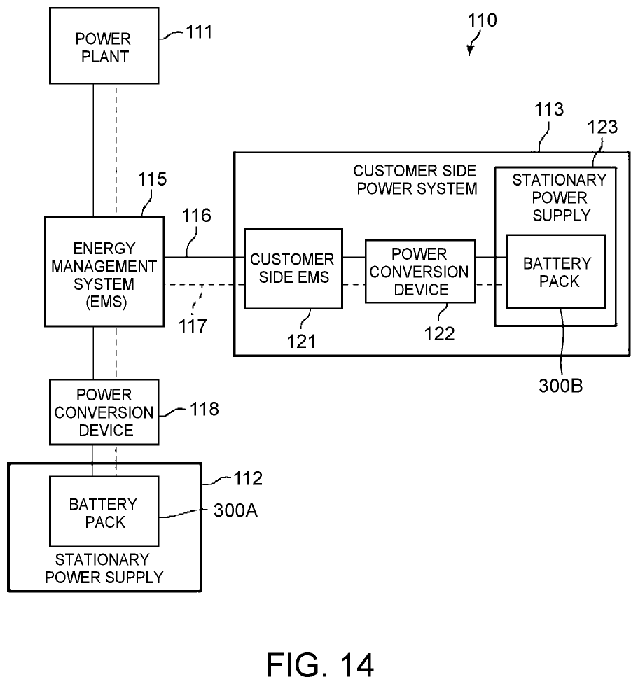

FIG. 13 is a partial transparency diagram schematically illustrating an example of the vehicle according to the embodiment.

A vehicle 400 illustrated in FIG. 13 includes a vehicle body 40 and a battery pack 300 according to the fourth embodiment. In the example illustrated in FIG. 13, the vehicle 400 is a four-wheeled vehicle.

This vehicle 400 may be equipped with the plurality of battery packs 300. In this case, the batteries (for example, unit cell or assembled battery) included in the battery pack 300 may be connected in series, connected in parallel, or in connected in a combination of series and parallel connections.

FIG. 13 illustrates an example in which the battery pack 300 is mounted in the engine room located in front of the vehicle body 40. As described above, the battery pack 300 may be mounted, for example, behind the vehicle body 40 or under the seat. This battery pack 300 can be used as the power supply for the vehicle 400. In addition, this battery pack 300 can recover the regenerative energy of the power of the vehicle 400.

The vehicle according to the fifth embodiment is equipped with the battery pack according to the fourth embodiment. Therefore, the vehicle is excellent in running performance and reliability.

### Sixth Embodiment

According to a sixth embodiment, a stationary power supply including the battery pack according to the fourth embodiment is provided.

Such a stationary power supply may include the assembled battery according to the third embodiment or the secondary battery according to the second embodiment instead of the battery pack according to the fourth embodiment. The stationary power supply according to the embodiment can realize a long life.

FIG. 14 is a block diagram illustrating an example of a system including a stationary power supply according to an embodiment. FIG. 14 is a diagram illustrating an application example to stationary power supplies 112 and 123 as an example of using battery packs 300A and 300B according to an embodiment. An example illustrated in FIG. 14 illustrates a system 110 in which the stationary power supplies 112 and 123 are used. The system 110 includes a power plant 111, the stationary power supply 112, a customer side power system 113, and an energy management system (EMS) 115. Further, a power network 116 and a communication network 117 are formed in the system 110, and the power plant 111, the stationary power supply 112, the customer side power system 113 and the EMS 115 are connected via a power network 116 and a communication network 117. The EMS 115 utilizes the power network 116 and the communication network 117 to control the stabilization of the entire system 110.

The power plant 111 produces a large amount of electric power from fuel sources such as thermal power and nuclear power. Power is supplied from the power plant 111 via the power network 116 and the like. In addition, the stationary power supply 112 is equipped with a battery pack 300A. The battery pack 300A can store power or the like supplied from the power plant 111. Further, the stationary power supply 112 can supply the power stored in the battery pack 300A via the power network 116 or the like. The system 110 is provided with a power conversion device 118. The power conversion device 118 includes a converter, an inverter, a transformer, and the like. Therefore, the power conversion device 118 can perform conversion between a direct current and an alternating current, conversion between alternating currents having different frequencies from each other, transformation (step-up and step-down), and the like. Therefore, the power conversion device 118 can convert the power from the power plant 111 into the power that can be stored in the battery pack 300A.

The customer side power system 113 includes a factory power system, a building power system, a household power system, and the like. The customer side power system 113 includes a customer side EMS 121, a power conversion device 122, and a stationary power supply 123. The stationary power supply 123 is equipped with a battery pack 300B. The customer side EMS 121 controls to stabilize the customer side power system 113.

The power from the power plant 111 and the power from the battery pack 300A are supplied to the customer side power system 113 via the power network 116. The battery pack 300B can store the power supplied to the customer side power system 113. In addition, like the power conversion device 118, the power conversion device 122 includes a converter, an inverter, a transformer, and the like. Therefore, the power conversion device 122 can perform conversion between a direct current and an alternating current, conversion between alternating currents having different frequencies from each other, transformation (step-up and step-down), and the like. Therefore, the power conversion device 122 can convert the power supplied to the customer side power system 113 into the power that can be stored in the battery pack 300B.

Note that the power stored in the battery pack 300B can be used, for example, for charging a vehicle such as an electric vehicle. In addition, the system 110 may also be provided with a natural energy source. In this case, the natural energy source generates power by natural energy such as wind power and solar power. Then, in addition to the power plant 111, electric power is supplied from the natural energy source via the power network 116.

### EXAMPLE

### Example 1

### <Manufacturing of Electrode Structure>

First, a negative electrode was prepared. A slurry for producing a negative electrode was prepared by mixing a negative electrode active material, a conductive agent, a binder, and a solvent. Li₄Ti₅O₁₂ was used as the negative electrode active material. Graphite powder was used as a conductive agent. Polyvinyl butyral was used as a binder. N-Methyl-2-pyrrolidone (NMP) was used as a solvent. A mass ratio of the negative electrode active material, the conductive agent, and the binder in the slurry was 100:5:1. A process of immersing a plain-woven Zn-plated brass sheet as a mesh negative electrode current collector in this slurry and drying, is repeated until the negative electrode active material-containing layer has a desired thickness, and then the negative electrode active material-containing layer is supplied to the roll press, thereby forming the negative electrode.

Next, the inorganic solid particles and the polymer material were mixed with N-methyl-2-pyrrolidone (NMP) to obtain a slurry for forming a composite layer. LATP(Li_{1.5}Al_{0.5}Ti_{1.5}(PO₄)₃) was used as the inorganic solid particles, and the polyvinyl butyral was used as the polymer material. The softening point of the polyvinyl butyral was 120° C. In the slurry, the mass ratio of the inorganic solid particles and the polymer material was 88:12. This slurry was applied onto one surface of the negative electrode by the doctor blade method at a coating speed of 0.5 m/min, and the obtained coating film was dried at a temperature of 120° C. In this way, a negative electrode/composite membrane electrode structure precursor in which a coating film was provided on the negative electrode was obtained.

Next, this electrode structure precursor was subjected to roll press processing. For the roll press processing, a press device equipped with two rollers on the top and bottom was used. The heating temperature of the roller was 130° C., and the press pressure of the roller was 5 kN. As a result, an electrode structure in which a composite layer was provided on the negative electrode surface was obtained. Since the base material layer does not exist in Example 1, the composite layer is a composite membrane.

### <Production of Secondary Battery>

In addition to the obtained electrode structure, a secondary battery was prepared using the positive electrode prepared by the following method and the aqueous electrolyte.

### [Manufacture of Positive Electrode]

A slurry for producing a positive electrode was prepared by mixing a positive electrode active material, a conductive agent, a binder, and a solvent. LiMn₂O₄ was used as the positive electrode active material. Graphite powder was used as a conductive agent. Polyvinylidene fluoride (PVdF) was used as the binder. N-Methyl-2-pyrrolidone (NMP) was used as a solvent. The mass ratio of the positive electrode active material, the conductive agent, and the binder in the slurry was 80:10:10. This slurry was applied to both surfaces of a positive electrode current collector, dried, and then pressed to obtain a positive electrode. As the positive electrode current collector, a Ti foil having a thickness of 12 μm was used.

### [Production of Electrode Group]

A positive electrode and an electrode structure were laminated to obtain a laminate. At this time, after impregnating the electrode structure with the aqueous electrolyte, the composite membrane surface was arranged so as to be located on the positive electrode side. The laminate was spirally wound so that the negative electrode side was located on the outermost circumference, and then pressed at 5 kN to produce a flat electrode group.

### [Battery Assembly]

The obtained electrode group was housed in a metal can, and an aqueous electrolyte prepared in the same manner as that impregnated into the electrode structure was injected to prepare a secondary battery.

### <Performance Evaluation of Secondary Battery> <Measurement of Internal Resistance>

First, a state of charge (SOC) was adjusted to 50%. The adjusted battery was pulse-discharged at a rate of 10 C, and a discharge voltage after 10 seconds was measured. The internal resistance of the secondary battery was calculated from the voltage before discharge and the discharge voltage of 10 C.

### <Charging/Discharging Test>

The charge/discharge efficiency was measured. Specifically, first, the secondary battery was charged at a constant current of 5 A in an environment of 25° C. until the battery voltage reached 2.7 V. That condition was maintained for 30 minutes. Thereafter, the battery was discharged to 2.1 V with a constant current of 5 A. That condition was maintained for 30 minutes. These series of operations were regarded as one charge/discharge cycle, and this was repeated 50 times. The discharge capacity and charge capacity of 50th cycle were measured for each secondary battery, and the charge/discharge efficiency (discharge capacity/charge capacity) was calculated using the measured values. Subsequently, after charging the secondary battery to a battery voltage of 2.7 V, after providing a 24-hour rest period, the charge capacity is measured again, and the storage performance (charge capacity after 24-hour rest/charge capacity immediately before rest) was evaluated. The result is illustrated in Table 4.

In Table 4, the column labeled “charge/discharge efficiency (%)” shows the value calculated as above, which is the discharge capacity after the 50-cycle test divided by the charge capacity. The column labeled “discharge capacity (mAh/g)” shows the discharge capacity at the 50th cycle in the 50-cycle test. The column labeled “storage performance (%)” shows the ratio of the charge capacity after 24 hours rest from the capacity when fully charged in the 51st cycle.

### <Peeling Strength Evaluation>

Regarding the obtained electrode group, the peeling strength σ1 of the negative electrode active material-containing layer-composite layer (composite membrane) interface was evaluated by the surface/interface cutting method described above. Specifically, both surfaces of the electrode group were washed with pure water, and then the electrode group was immersed in pure water and left for 48 hours or more. Thereafter, both surfaces were further rinsed with pure water and dried in a vacuum drying oven at 100° C. for 48 hours or more to prepare the measurement sample of the electrode group. The prepared electrode group was measured using the surface/interface cutting method. As the measuring device, for example, DN-GS manufactured by Daipla Wintes Co., Ltd. was used. For the cutting blade, for example, a ceramic blade made of Borazone material with a blade width of 1.0 mm was used, and the measurement conditions were a rake angle of 20° and a burr angle of 10°.

First, the composite layer was cut in the vertical direction with a pressing load of 1 N (constant load mode). Here, cutting was performed at a constant speed of horizontal speed 2 μm/sec and vertical speed 0.2 μm/sec at a shear angle of 45°. When the horizontal load (horizontal force) applied to the blade is decreased due to the composite layer peeling off from the negative electrode active material-containing layer, the position of the vertical blade was constantly maintained by controlling the vertical load to be 0.5N. Thereafter, the horizontal force (horizontal load) was measured at a horizontal speed of 2 μm/sec. After the horizontal force due to the peeling becomes constant, the measurement was continued over a region of 1 mm length, and the average strength of the horizontal force measured in this length region was defined as the peeling strength σ1. Note that both the measurement temperature and the sample temperature was room temperature (25° C.). The measurement result of the electrode group produced in Example 1 was that the peeling strength σ1 was 7 N/cm. The peeling strength σ2 measured in the same manner was 0 N/cm.

In addition, the ratio a/b of the second surface PD_{C1} (density a) to the first surface ND_{C1} (density b) in the composite layer was 1.12.

### <Measurement of Air Permeability Coefficient>

The electrode group was separated from other parts of the secondary battery, the electrode group was rinsed on both surfaces with pure water, and then immersed in pure water and left for 48 hours or more. Thereafter, ultrasonic vibration was further applied to peel off the positive electrode mixture layer, and the electrode structure was taken out. Both surfaces of this electrode structure were rinsed with pure water, dried in a vacuum drying oven at 100° C. for 48 hours or more, and then the air permeability coefficient was measured. The thickness (m) of the electrode structure was measured at four points of the electrode structure taken out in this way. At each of the four measurement points, the electrode structure is sandwiched between a pair of stainless steel plates with opened holes with a diameter of 10 mm, and air is sent at pressure p from the holes in one of the stainless steel plates. The pressure p was 1000 Pa, 2500 Pa, 4000 Pa, and 6000 Pa. Then, the gas amount Q of the air leaking from the hole of the other stainless steel plate is measured. Therefore, the area (25 πmm²) of the hole was used as the measurement area A, and 0.000018 Pa·s is used as the viscosity coefficient σ. The gas amount Q was calculated by measuring the amount δ (m³) leaking from the hole in 100 seconds and dividing the measured amount δ by 100.

Then, the gas amount Q with respect to the pressure p is plotted for the four measured points, and the slope (dQ/dp) of the gas amount Q with respect to the pressure p was calculated by linear fitting (least squares method). Then, the air permeability coefficient KT was calculated by multiplying the calculated slope (dQ/dp) by (σ·L)/A. Then, the value at the location where the air permeability coefficient is the lowest among the four locations was defined as the air permeability coefficient of the joined body between the composite layer and the negative electrode, that is, the electrode structure, and the air permeability coefficient was 2.5×10⁻¹⁷ m².

Tables 1 to 3 summarize the composition and production conditions of the electrode structure in Example 1 described above and Examples 2 to 18 described later. Table 4 also summarizes the results of the surface/interface cutting method (SAICAS method) and the evaluation of the air permeability coefficient of the electrode structure obtained for the electrode group manufactured in Examples 1 to 18. As the composition of the separator, the inorganic solid particles used as the material of the composite layer, the polymer material, and their mass ratios are shown. The conditions for manufacturing the separator include the drying temperature and coating speed of the slurry for forming the composite layer, and the roller heating temperature and press pressure during the roll press processing.

Similarly, the composition of the separator, the manufacturing conditions of the electrode structure, the negative electrode composition, the conditions of manufacturing the negative electrode, the peeling strengths σ1 and σ2, the ratio of density (a/b), the air permeability coefficient of the electrode structure, the resistance, the charge/discharge efficiency, the discharge capacity, and the storage performance, which are used in Comparative Examples 1 to 3 described later are summarized in Tables 5 to 8. Items that could not be evaluated are indicated by “-” under the corresponding item in the table.

### Example 2

### <Manufacturing of Electrode Structure>

An electrode structure was manufactured by the same method as in Example 1 except that the temperature of the roller when manufacturing the electrode structure was changed to 50° C.

### <Production of Secondary Battery>

The secondary battery was prepared and evaluated by the same procedure as in Example 1 except that the obtained electrode structure was used instead of the electrode structure obtained in Example 1.

When the peeling strengths σ1 and σ2 were evaluated in Example 2 in the same manner as in Example 1, σ1 was 9 N/cm and σ2 was 0.1 N/cm. Moreover, when the air permeability coefficient of the electrode structure of the composite layer and the negative electrode active material-containing layer was evaluated in Example 2, the air permeability coefficient was 1.0×10⁻¹⁸ m².

In addition, the ratio a/b of the second surface PD_{C1} (density a) to the first surface ND_{C1} (density b) in the composite layer was 1.06.

### Example 3

An electrode structure was manufactured by the same method as in Example 1 except that the mass ratio of the inorganic solid particles and the polymer material in the slurry used for preparing the composite layer was changed to 97:3.

### <Production of Secondary Battery>

The secondary battery was prepared and evaluated by the same procedure as in Example 1 except that the obtained electrode structure was used instead of the electrode structure obtained in Example 1.

When the same evaluation as in Example 1 was performed, σ1 was 1.5 N/cm. σ2 was 0.1 N/cm. In addition, the air permeability coefficient of the electrode structure was 5×10⁻¹⁶ m².

In addition, the ratio a/b of the second surface PD_{C1} (density a) to the first surface ND_{C1} (density b) in the composite layer was 1.15.

### Example 4

An electrode structure was manufactured by the same method as in Example 1 except that alumina (Al2O3) was used instead of LATP.

### <Production of Secondary Battery>

The secondary battery was prepared and evaluated by the same procedure as in Example 1 except that the obtained electrode structure was used instead of the electrode structure obtained in Example 1.

In Example 4, σ1 was 7 N/cm. σ2 was 0 N/cm. In addition, the air permeability coefficient of the electrode structure was 5×10⁻¹⁷ m².

In addition, the ratio a/b of the second surface PD_{C1} (density a) to the first surface ND_{C1} (density b) in the composite layer was 1.15.

An example in which the electrode structure is produced under various process conditions is shown according to Examples 5 to 10 below.

### Examples 5 to 10

### <Manufacturing of Electrode Structure>

In Example 5, an electrode structure was manufactured in the same method as Example 1 except that the press pressure in the roll press processing after forming the composite layer on the surface of the negative electrode active material-containing layer was changed to 10 kN. In Examples 5 to 10, the electrode structure was manufactured in the same manner as in Example 1 except that the manufacturing conditions of the composite membrane (separator) and the negative electrode active material-containing layer were changed as shown in Tables 1 to 3.

### <Manufacturing and Performance Evaluation of Secondary Battery>

A secondary battery was prepared and evaluated by the same procedure as in Example 1 except that the obtained electrode structure was used instead of the electrode structure obtained in Example 1.

Table 4 summarize the σ1 and σ2, the air permeability coefficients, and the ratio a/b of the second surface PD_{C1} (density a) to the first surface ND_{C1} (density b) in the composite layer of Examples 5 to 10.

Examples 11 to 16 below show examples in which various materials are used for each member.

### Examples 11 to 16

### <Manufacturing of Electrode Structure>

In Examples 11 to 16, an electrode structure was manufactured in the same manner as in Example 1 except that the materials used for the composite membrane (separator) and the negative electrode active material-containing layer were changed as shown in Tables 5 to 7.

### <Manufacturing and Performance Evaluation of Secondary Battery>

A secondary battery was prepared and evaluated by the same procedure as in Example 1 except that the obtained electrode structure was used instead of the electrode structure obtained in Example 1.

The σ1 and σ2, the air permeability coefficient, and the ratio a/b of the second surface PD_{C1} (density a) to the first surface ND_{C1} (density b) in the composite layer of Examples 11 to 16 were shown in Table 8.

### Comparative Example 1

A negative electrode and a positive electrode produced in the same procedure as in Example 1 were prepared. In addition, a composite membrane was prepared as a separator. As a base material layer, a cellulosic non-woven fabric with a thickness of 15 μm was prepared. Next, the inorganic solid particles and the polymer material were mixed with N-methyl-2-pyrrolidone (NMP) to obtain a slurry for forming a composite layer. LATP(Li1.5Al0.5Ti1.5(PO4)3) was used as the inorganic solid particles, and the polyvinyl butyral was used as the polymer material. The softening point of the polyvinyl butyral was 120° C. In the slurry, the mass ratio of the inorganic solid particles and the polymer material was 88:12. This slurry was applied onto one surface of the base material layer by the doctor blade method at a slurry coating speed of 0.5 m/min, and the obtained coating film was dried at a temperature of 120° C. In this way, a composite membrane precursor having a coating film on the base material layer was obtained.

Next, the composite membrane precursor was subjected to the roll press processing. For the roll press processing, a press device equipped with two rollers on the top and bottom was used. The heating temperature of the roller was 130° C., and the press pressure of the roller was 10 kN. From the above, the composite membrane as the separator was obtained.

### <Production of Secondary Battery>

In addition to the negative electrode similar to that of Example 1, a composite membrane similar to that of Example 1 was prepared as the first separator and the second separator. In addition, the same positive electrode and the aqueous electrolyte as in Example 1 were prepared.

The positive electrode, the composite membrane (first separator), the negative electrode, and the composite membrane (second separator) were laminated in this order to obtain a laminate. At this time, the composite membrane was arranged so that the composite layer was located on the negative electrode side and the base material layer was located on the positive electrode side. The laminate was spirally wound so that the negative electrode was located on the outermost circumference, and then pressed to produce a flat electrode group.

The secondary battery was prepared and evaluated by the same procedure as in Example 1 except that the obtained electrode group was used in place of the electrode group obtained in Example 1.

Regarding the peeling strength, in the electrode group of Comparative Example 1, the surface of the composite layer and the surface of the negative electrode active material-containing layer are in contact with each other, but these members are not joined. Therefore, the peeling strength σ1 on the first surface can be regarded as zero. The same applies to σ2. Moreover, since the electrode structure is not formed, the air permeability coefficient is not measured. In addition, the ratio a/b of the second surface PD_{C1} (density a) to the first surface ND_{C1} (density b) in the composite layer was 1.

### Comparative Example 2

### <Production of Negative Electrode>

A slurry for producing a negative electrode similar to that prepared in Example 1 was prepared. This slurry was applied on both surfaces of Zn foil having a thickness of 50 μm and dried at 120° C. to provide a coating film of a negative electrode active material-containing layer. A laminate of Zn foil (current collector foil) and a coating film of a negative electrode active material-containing layer were subjected to the roll press processing to produce the negative electrode including the current collector foil and the negative electrode active material-containing layer. The roller temperature was room temperature (25° C.) and the press pressure was 10 kN.

### <Manufacturing of Electrode Structure>

Subsequently, the composite layer was formed on the surface of the negative electrode active material-containing layer of the negative electrode. The slurry for forming the composite layer similar to that prepared in Example 1 was prepared. Using this slurry, the coating, the drying, and the roll press processing were performed under the same conditions as the formation of the composite membrane in Example 1 except that the surface of the negative electrode active material-containing layer is coated instead of the base material layer. As a result, the electrode structure in which the current collector foil, the negative electrode active material-containing layer, and the composite layer were integrated was obtained.

### <Production of Secondary Battery>

The obtained electrode structure was immersed in the same aqueous electrolyte as in Example 1. The secondary battery was prepared and evaluated by the same procedure as in Example 1 except that this electrode structure was used in place of the electrode structure obtained in Example 1.

When the peeling strength σ1 was evaluated for the obtained electrode group in the same manner as in Example 1, σ1 was 9 N/cm in Comparative Example 2. σ2 was 0 N/cm. In addition, in the electrode group of Comparative Example 2, it was difficult to peel off the negative electrode current collector without causing damage, so the joint body of the composite layer and the negative electrode, that is, the air permeability coefficient of the electrode structure was not measured. In addition, the ratio a/b of the second surface PD_{C1} (density a) to the first surface ND_{C1} (density b) in the composite layer was 1.12.

### Comparative Example 3

### <Manufacturing of Electrode Structure>

An electrode structure was manufactured by the same method as in Example 1 except that the temperature of the roller when manufacturing the electrode structure was changed to room temperature (25° C.)

### <Production of Secondary Battery>

The secondary battery was prepared and evaluated by the same procedure as in Example 1 except that the obtained electrode structure was used instead of the electrode structure obtained in Example 1.

When the peeling strength c1 was evaluated in Comparative Example 3 in the same manner as in Example 1, σ1 was 8 N/cm. σ2 was 0.1 N/cm. Moreover, when the air permeability coefficient of the electrode structure of the composite layer and the negative electrode active material-containing layer was evaluated in Comparative Example 3, the air permeability coefficient was 9.0×10⁻¹⁷ m².

In addition, the ratio a/b of the second surface PD_{C1} (density a) to the first surface ND_{C1} (density b) in the composite layer was 1.03.

TABLE 1

| | | | | Production condition of negative electrode | | | |
|---|---|---|---|---|---|---|---|
| | Negative electrode active material-containing layer | | | active material-containing layer | | | |
| | composition | | | | | Coating film press | Coating film press |
| | Negative | | | | | temperature of | pressure of |
| | electrode | | | | Slurry | negative electrode | negative electrode |
| | active | Conductive | | Slurry drying | coating | active material- | active material- |
| | material | agent | Binder | temperature | speed | containing layer | containing layer |
| | (mass ratio) | (mass ratio) | (mass ratio) | (° C.) | (m/minute) | (° C.) | (kN) |
| Example 1 | Li₄Ti₅O₁₂ | Graphite powder | Polyvinyl butyral | 120 | 1 | 25° C. | 5 |
| | (100) | (5) | (1) | | | | |
| Example 2 | Li₄Ti₅O₁₂ | Graphite powder | Polyvinyl butyral | 120 | 1 | 25° C. | 5 |
| | (100) | (5) | (1) | | | | |
| Example 3 | Li₄Ti₅O₁₂ | Graphite powder | Polyvinyl butyral | 120 | 1 | 25° C. | 5 |
| | (100) | (5) | (1) | | | | |
| Example 4 | Li₄Ti₅O₁₂ | Graphite powder | Polyvinyl butyral | 120 | 1 | 25° C. | 5 |
| | (100) | (5) | (1) | | | | |
| Example 5 | Li₄Ti₅O₁₂ | Graphite powder | Polyvinyl butyral | 120 | 1 | 25° C. | 5 |
| | (100) | (5) | (1) | | | | |
| Example 6 | Li₄Ti₅O₁₂ | Graphite powder | Polyvinyl butyral | 120 | 1 | 25° C. | 5 |
| | (100) | (5) | (1) | | | | |
| Example 7 | Li₄Ti₅O₁₂ | Graphite powder | Polyvinyl butyral | 120 | 1 | 25° C. | 5 |
| | (100) | (5) | (1) | | | | |
| Example 8 | Li₄Ti₅O₁₂ | Graphite powder | Polyvinyl butyral | 120 | 1 | 25° C. | 5 |
| | (100) | (5) | (1) | | | | |
| Example 9 | Li₄Ti₅O₁₂ | Graphite powder | Polyvinyl butyral | 120 | 1 | 25° C. | 5 |
| | (100) | (5) | (1) | | | | |
| Example 10 | Li₄Ti₅O₁₂ | Graphite powder | Polyvinyl butyral | 120 | 1 | 25° C. | 5 |
| | (100) | (5) | (1) | | | | |

TABLE 2

| | | | Electrode structure manufacturing condition | | |
|---|---|---|---|---|---|
| | Separator composition | | Slurry drying | Slurry coating | Roller heating |
| | Inorganic solid particle | Polymer material | temperature | speed | temperature |
| | (mass ratio) | (mass ratio) | (° C.) | (m/minute) | (° C.) |
| Example 1 | Li_{1.5}Al_{0.5}Ti_{1.5}(PO₄)₃ | Polyvinyl butyral | 120 | 0.5 | 130 |
| | (88) | (12) | | | |
| Example 2 | Li_{1.5}Al_{0.5}Ti_{1.5}(PO₄)₃ | Polyvinyl butyral | 120 | 0.5 | 50 |
| | (88) | (12) | | | |
| Example 3 | Li_{1.5}Al_{0.5}Ti_{1.5}(PO₄)₃ | Polyvinyl butyral | 120 | 0.5 | 130 |
| | (97) | (3) | | | |
| Example 4 | Al₂O₃ | Polyvinyl butyral | 120 | 0.5 | 130 |
| | (88) | (12) | | | |
| Example 5 | Li_{1.5}Al_{0.5}Ti_{1.5}(PO₄)₃ | Polyvinyl butyral | 120 | 0.5 | 130 |
| | (88) | (12) | | | |
| Example 6 | Li_{1.5}Al_{0.5}Ti_{1.5}(PO₄)₃ | Polyvinyl butyral | 140 | 0.5 | 130 |
| | (88) | (12) | | | |
| Example 7 | Li_{1.5}Al_{0.5}Ti_{1.5}(PO₄)₃ | Polyvinyl butyral | 120 | 1 | 130 |
| | (88) | (12) | | | |
| Example 8 | Li_{1.5}Al_{0.5}Ti_{1.5}(PO₄)₃ | Polyvinyl butyral | 120 | 0.2 | 130 |
| | (88) | (12) | | | |
| Example 9 | Li_{1.5}Al_{0.5}Ti_{1.5}(PO₄)₃ | Polyvinyl butyral | 120 | 0.5 | 110 |
| | (88) | (12) | | | |
| Example 10 | Li_{1.5}Al_{0.5}Ti_{1.5}(PO₄)₃ | Polyvinyl butyral | 120 | 0.5 | 150 |
| | (88) | (12) | | | |

TABLE 3

| | Manufacturing condition of electrode structure | |
|---|---|---|
| | | Press |
| | | pressure |
| | Procedure of manufacturing | (kN) |
| Example 1 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 2 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 3 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 4 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 5 | Form negative electrode active material-containing layer so as to | 10 |
| | include mesh negative current collector, and produce negative electrode. | |
| | Form composite layer by slurry coating for forming composite layer on | |
| | surface of negative electrode and press | |
| Example 6 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 7 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 8 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 9 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 10 | Form negative electrode active material-containing layer so as to | 5 |
| | include mesh negative current collector, and produce negative electrode. | |
| | Form composite layer by slurry coating for forming composite layer on | |
| | surface of negative electrode and press | |

TABLE 4

| | Various measurement result | | | | | | | |
|---|---|---|---|---|---|---|---|---|
| | | | | Air permeability | Performance evaluation | | | |
| | | | | coefficient | | Charge/ | | |
| | | | | of electrode | | discharge | Discharge | Storage |
| | σ 1 | σ 2 | | structure | Resistance | efficiency | capacity | performance |
| | (N/m) | (N/m) | a/b | (m²) | (mΩ) | (%) | (mAh/g) | (%) |
| Example 1 | 7 | 0 | 1.12 | 2.5 × 10⁻¹⁷ | 250 | 94 | 161 | 78 |
| Example 2 | 9 | 0.1 | 1.06 | 1 × 10⁻¹⁶ | 194 | 88 | 159 | 70 |
| Example 3 | 1.5 | 0.1 | 1.15 | 5 × 10⁻¹⁶ | 158 | 85 | 164 | 62 |
| Example 4 | 7 | 0 | 1.15 | 5 × 10⁻¹⁷ | 274 | 93 | 161 | 75 |
| Example 5 | 7 | 0 | 1.06 | 1.5 × 10⁻¹⁷ | 331 | 92 | 160 | 71 |
| Example 6 | 7 | 0 | 1.1 | 1 × 10⁻¹⁷ | 455 | 88 | 145 | 72 |
| Example 7 | 7 | 0 | 1.12 | 3 × 10⁻¹⁷ | 316 | 85 | 157 | 66 |
| Example 8 | 7 | 0 | 1.07 | 1 × 10⁻¹⁷ | 793 | 90 | 148 | 74 |
| Example 9 | 7 | 0.1 | 1.05 | 8 × 10⁻¹⁷ | 189 | 83 | 165 | 63 |
| Example 10 | 7 | 0 | 1.11 | 6.5 × 10⁻¹⁸ | 870 | 90 | 144 | 68 |

TABLE 5

| | | | | Production condition of negative electrode active | | | |
|---|---|---|---|---|---|---|---|
| | Negative electrode active material-containing layer | | | material-containing layer | | | |
| | composition | | | | | Coating film press | Coating film press |
| | Negative | | | | | temperature of | pressure of |
| | electrode | | | | Slurry | negative electrode | negative electrode |
| | active | Conductive | | Slurry drying | coating | active material- | active material- |
| | material | agent | Binder | temperature | speed | containing layer | containing layer |
| | (mass ratio) | (mass ratio) | (mass ratio) | (° C.) | (m/minute) | (° C.) | (kN) |
| Example 11 | NTO | Graphite powder | Polyvinyl butyral | 120 | 1 | 25° C. | 5 |
| | (100) | (5) | (1) | | | | |
| Example 12 | Li₄Ti₅O₁₂ | Graphite powder | PV d F | 120 | 1 | 25° C. | 5 |
| | (100) | (5) | (1) | | | | |
| Example 13 | NTO | Graphite powder | PV d F | 120 | 1 | 25° C. | 5 |
| | (100) | (5) | (1) | | | | |
| Example 14 | Li₄Ti₅O₁₂ | Graphite powder | Polyvinyl butyral | 120 | 1 | 25° C. | 5 |
| | (100) | (5) | (1) | | | | |
| Example 15 | Li₄Ti₅O₁₂ | Graphite powder | Polyvinyl butyral | 120 | 1 | 25° C. | 5 |
| | (100) | (5) | (1) | | | | |
| Example 16 | Li₄Ti₅O₁₂ | Graphite powder | Polyvinyl butyral | 120 | 1 | 25° C. | 5 |
| | (100) | (5) | (1) | | | | |
| Comparative | Li₄Ti₅O₁₂ | Graphite powder | Polyvinyl butyral | 120 | 1 | 25° C. | 10 |
| Example 1 | (100) | (5) | (1) | | | | |
| Comparative | Li₄Ti₅O₁₂ | Graphite powder | Polyvinyl butyral | 120 | 1 | 25° C. | 10 |
| Example 2 | (100) | (5) | (1) | | | | |
| Comparative | Li₄Ti₅O₁₂ | Graphite powder | Polyvinyl butyral | 120 | 1 | 25° C. | 5 |
| Example 3 | (100) | (5) | (1) | | | | |

TABLE 6

| | | | Electrode structure manufacturing condition | | |
|---|---|---|---|---|---|
| | Separator composition | | Slurry drying | Slurry coating | Roller heating |
| | Inorganic solid particle | Polymer material | temperature | speed | temperature |
| | (mass ratio) | (mass ratio) | (° C.) | (m/minute) | (° C.) |
| Example 11 | Li_{1.5}Al_{0.5}Ti_{1.5}(PO₄)₃ | Polyvinyl butyral | 120 | 0.5 | 130 |
| | (88) | (12) | | | |
| Example 12 | Li_{1.5}Al_{0.5}Ti_{1.5}(PO₄)₃ | Polyvinyl butyral | 120 | 0.5 | 130 |
| | (88) | (12) | | | |
| Example 13 | Li_{1.5}Al_{0.5}Ti_{1.5}(PO₄)₃ | Polyvinyl butyral | 120 | 0.5 | 130 |
| | (88) | (12) | | | |
| Example 14 | Li₇La₃Zr₂O₁₂ | Polyvinyl butyral | 120 | 0.5 | 130 |
| | (88) | (12) | | | |
| Example 15 | Li_{1.5}Al_{0.5}Ti_{1.5}(PO₄)₃ | Polyvinyl formal | 120 | 0.5 | 130 |
| | (88) | (12) | | | |
| Example 16 | Li₇La₃Zr₂O₁₂ | Polyvinyl formal | 120 | 0.5 | 130 |
| | (88) | (12) | | | |
| Comparative | Li_{1.5}Al_{0.5}Ti_{1.5}(PO₄)₃ | Polyvinyl butyral | 120 | 0.5 | 130 |
| Example 1 | (88) | (12) | | | |
| Comparative | Li_{1.5}Al_{0.5}Ti_{1.5}(PO₄)₃ | Polyvinyl butyral | 120 | 0.5 | 130 |
| Example 2 | (88) | (12) | | | |
| Comparative | Li_{1.5}Al_{0.5}Ti_{1.5}(PO₄)₃ | Polyvinyl butyral | 120 | 0.5 | 25 |
| Example 3 | (88) | (12) | | | |

TABLE 7

| | Manufacturing condition of electrode structure | |
|---|---|---|
| | | Press |
| | | pressure |
| | Procedure of manufacturing | (kN) |
| Example 11 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 12 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 13 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 14 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 15 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Example 16 | Form negative electrode active material-containing layer so as to | 5 |
| | include mesh negative current collector, and produce negative electrode. | |
| | Form composite layer by slurry coating for forming composite layer on | |
| | surface of negative electrode and press | |
| Comparative | Form negative electrode active material-containing layer so as to | 0 |
| Example 1 | include mesh negative current collector, and stack separator containing | (No press) |
| | composite layer separately formed onto negative electrode active | |
| | material-containing layer | |
| Comparative | Form negative electrode active material-containing layer by mixture | 10 |
| Example 2 | slurry coating on negative electrode current collector, and form composite | |
| | layer on surface of negative electrode active material-containing layer | |
| Comparative | Form negative electrode active material-containing layer so as to | 5 |
| Example 3 | include mesh negative current collector, and produce negative electrode. | |
| | Form composite layer by slurry coating for forming composite layer on | |
| | surface of negative electrode and press | |

TABLE 8

| | Various measurement result | | | | | | | |
|---|---|---|---|---|---|---|---|---|
| | | | | Air permeability | Performance evaluation | | | |
| | | | | coefficient | | Charge/ | | |
| | | | | of electrode | | discharge | Discharge | Storage |
| | σ 1 | σ 2 | | structure | Resistance | efficiency | capacity | performance |
| | (N/m) | (N/m) | a/b | (m²) | (mΩ) | (%) | (mAh/g) | (%) |
| Example 11 | 7 | 0 | 1.12 | 1.5 × 10⁻¹⁷ | 266 | 92 | 258 | 71 |
| Example 12 | 5 | 0 | 1.12 | 1.5 × 10⁻¹⁷ | 253 | 83 | 163 | 61 |
| Example 13 | 5 | 0 | 1.12 | 1.5 × 10⁻¹⁷ | 251 | 82 | 266 | 59 |
| Example 14 | 7 | 0 | 1.11 | 1.5 × 10⁻¹⁷ | 230 | 92 | 160 | 74 |
| Example 15 | 8 | 0 | 1.14 | 3 × 10⁻¹⁷ | 254 | 89 | 163 | 70 |
| Example 16 | 8 | 0 | 1.14 | 3 × 10⁻¹⁷ | 247 | 88 | 160 | 69 |
| Comparative | — | — | 1 | — | 218 | 91 | 160 | 35 |
| Example 1 | | | | | | | | |
| Comparative | 9 | 0 | 1.12 | — | 5000 | 10 | 27 | 0 |
| Example 2 | | | | | | | | |
| Comparative | 8 | 0.1 | 1.03 | 9 × 10⁻¹⁷ | 169 | 75 | 160 | 44 |
| Example 3 | | | | | | | | |

As shown in Table 4, by adopting the manufacturing procedure shown in the table in Examples 1 to 3, the electrode group in which the peeling strength σ1 in the first interface was larger than the peeling strength σ2 in the second surface was obtained. From these results, it can be determined that the electrode group had good adhesion on the first surface and no twisting or the like occurred. Furthermore, in Examples 1-4, the air permeability coefficient of the electrode structure was 1×10⁻¹⁵ m² or less. Therefore, it was found that a dense composite membrane was obtained. In addition, the ratio a/b of the second surface PD_{C1} (density a) to the first surface ND_{C1} (density b) in the composite layer was 1.05 or more.

Also in Examples 5 to 12 in which the electrode structures were prepared under various process conditions, the electrode group in which the peeling strength σ1 on the first surface was larger than the peeling strength σ2 on the second surface was obtained. Furthermore, since the air permeability coefficient of the electrode structure was 1×10⁻¹⁵ m² or less, it was found that a dense composite membrane was obtained. In addition, the ratio a/b of the second surface PD_{C1} (density a) to the first surface ND_{C1} (density b) in the composite layer was 1.05 or more.

Also in Examples 4 and 13 to 18 in which various materials were used for each member, the electrode group in which the peeling strength σ1 on the first surface was larger than the peeling strength σ2 on the second surface was obtained. Furthermore, since the air permeability coefficient of the electrode structure was 1×10⁻¹⁵ m² or less, it was found that a dense composite membrane was obtained. In addition, the ratio a/b of the second surface PD_{C1} (density a) to the first surface ND_{C1} (density b) in the composite layer was 1.05 or more.

The composition and manufacturing conditions of the electrode structure in Comparative Examples 1 to 3 and the evaluation results by the SAICAS method are summarized in the table. As described above, since the air permeability coefficient of the electrode structure could not be evaluated in Comparative Examples 1 and 2, “-” is written under the corresponding item in the table. The table shows the items corresponding to or similar to the items shown in the table for Examples 1 to 18, respectively. For example, in Comparative Example 1, since the composite layer and the negative electrode active material-containing layer are not joined, the peeling strength σ1 on the first surface can be regarded as zero, and in the table, the value of σ1 is written as 0 N/cm for convenience.

As described above, in Comparative Example 1, the laminate or the electrode structure of the negative electrode and the separator having the same peeling strength σ1 on the separator side of the negative electrode active material-containing layer and the peeling strength σ2 on the second surface was obtained. In addition, in Comparative Example 3, the ratio a/b of the second surface PD_{C1} (density a) to the first surface ND_{C1} (density b) in the composite layer was 1.05 or less.

Tables 4 and 8 show the results of battery performance evaluation of the secondary batteries according to Examples 1 to 16 and Comparative Examples 1 to 3. In Tables 4 and 8, the column labeled “resistance (mΩ)” shows the internal resistance calculated as described above, and the column labeled “charge/discharge efficiency (%)” shows a value obtained by dividing the discharge capacity after the 50-cycle test by the charge capacity. The column labeled “discharge capacity (mAh/g)” shows the discharge capacity at the 50th cycle in the 50-cycle test. The column labeled “storage performance (%)” shows the ratio of the charge capacity after 24 hours rest from the capacity when fully charged in the 51st cycle.

As is clear from Tables 4 and 8, the storage performance of the secondary battery using the electrode structure of Examples 1 to 16 was higher than that of the secondary battery of Comparative Examples 1 to 3. Regarding the performance difference from Comparative Example 1, there is no liquid pool at the interface between the negative electrode and the separator (the first surface of the active material-containing layer and the composite layer) in the secondary battery according to Examples 1 to 16, so it is considered that the effect of reductive decomposition by the stored water has disappeared. On the other hand, in Comparative Example 1, since the separator and the negative electrode were only laminated, it is presumed that a liquid pool was generated in those interfaces. In Comparative Example 1, it is determined that water electrolysis occurred when the members constituting the negative electrode came into contact with the water in the liquid pool, and self-discharge proceeded.

From the results of the SAICAS measurement shown in Table 8, it was determined that there was no liquid pool in Comparative Example 2, but each performance was significantly lower in Comparative Example 2. It is presumed that this is because the electrolyte solution could not be pre-impregnated due to the manufacturing method adopted in the electrode structure according to Comparative Example 2. First, since the drying temperature of each slurry forming the negative electrode active material-containing layer and the composite layer is high, the water solvent of the aqueous electrolyte evaporates, so the aqueous electrolyte cannot be impregnated until both the negative electrode active material-containing layer and the composite layer are formed. In Comparative Example 2, when both the negative electrode active material-containing layer and the composite layer are prepared, the current collecting foil is provided on one surface of the negative electrode active material-containing layer, and the composite layer is formed on the other side on the back side. Since the liquid cannot be permeated through the current collector foil, the aqueous electrode cannot be impregnated into the negative electrode active material-containing layer from the surface on the current collector foil side. Although the air permeability coefficient was not measured in Comparative Example 2 for the reason described above, it can be determined that a dense composite layer is obtained at least to some extent because the conditions for forming the composite layer are the same as those in Example 1. It is also difficult to allow the liquid to permeate through such a dense composite layer, and it is considered that the aqueous electrolyte is hardly impregnated into the negative electrode active material-containing layer from the surface on the composite layer side. As a result, in Comparative Example 2, the amount of aqueous electrolyte impregnated into the electrode structure was small, and it is considered that the battery performance was significantly deteriorated.

In Comparative Example 3, although the composition and layer structure were the same as those used for the composite layer in Example 1-3, the storage performance was low. In Comparative Example 3, it is presumed that the electrolysis proceeded because the density of the composite layer was low and the water insulation was insufficient.

According to one or more embodiments and examples described above, the electrode group includes a negative electrode that includes a negative electrode active material-containing layer and a mesh negative electrode current collector, at least a part of the mesh negative electrode current collector existing inside the negative electrode active material-containing layer, a positive electrode including the positive electrode active material-containing layer, and a separator that includes a composite membrane containing inorganic solid particles and a polymer material, wherein the composite membrane has a first surface joined to the negative electrode active material-containing layer and a second surface joined to the positive electrode active material-containing layer, at least one of a first polymer material constituting the negative electrode active material-containing layer is the same as a second polymer material constituting the composite membrane, a ratio a/b of a density a of 20% of the composite membrane from the second surface toward the first surface and a density b of 20% of the composite membrane from the first surface toward the second surface is greater than 1.05, a peeling strength σ1 of an interface between the composite membrane and the negative electrode active material-containing layer is greater than a peeling strength σ2 of the interface between the composite membrane and the positive electrode active material-containing layer, and an air permeability coefficient of a joined body of the composite membrane and the negative electrode is 1×10⁻¹⁹ m² or more and 1×10⁻¹⁵ m² or less.

The word “density” can be referred as “denseness”. The density (denseness) is a proportion occupied by a portion other than pores in a region. In other words, the density (denseness) is a ratio occupied by solid substances in a region.

According to the above configuration, it is possible to provide the electrode group, the secondary battery and the battery pack, and the vehicle and the stationary power supply including the battery pack capable of realizing the secondary battery that shows the high charge/discharge efficiency, improves the rate characteristics, and suppresses the self-discharge.

Although some embodiments of the present invention have been described, these embodiments are presented as examples and are not intended to limit the scope of the invention. These novel embodiments can be implemented in various other forms, and various omissions, replacements, and changes can be made without departing from the spirit of the invention. These embodiments and modifications thereof are included in the scope and the gist of the invention, and are also included in the invention described in the claims and the scope equivalent thereto.

What is claimed is:

1. An electrode group, comprising:
a negative electrode that includes a negative electrode active material-containing layer and a mesh negative electrode current collector, at least a part of the mesh negative electrode current collector existing inside the negative electrode active material-containing layer;
a positive electrode including a positive electrode active material-containing layer; and
a separator including a composite membrane having a first surface joined to the negative electrode active material-containing layer and a second surface joined to the positive electrode active material-containing layer,
wherein the negative electrode active material-containing layer contains a first polymer material,
the composite membrane contains inorganic solid particles and a second polymer material,
at least one of the first polymer material constituting the negative electrode active material-containing layer is the same as the second polymer material constituting the composite membrane, a ratio a/b of a denseness a of 20% of the composite membrane from the second surface toward the first surface and a denseness b of 20% of the composite membrane from the first surface toward the second surface is greater than 1.05, a peeling strength σ1 of an interface between the composite membrane and the negative electrode active material-containing layer is greater than a peeling strength σ2 of the interface between the composite membrane and the positive electrode active material-containing layer, and an air permeability coefficient of a joined body of the composite membrane and the negative electrode is 1×10⁻¹⁹ m² or more and 1×10⁻¹⁵ m² or less.

2. The electrode group according to claim 1, wherein a softening point of the polymer material is 100° C. or higher.

3. The electrode group according to claim 1, wherein the joined body has the air permeability coefficient of 1×10⁻¹⁶ m² or less.

4. The electrode group according to claim 1, wherein the peeling strength σ1 and the peeling strength σ2 satisfy a relationship of σ1>10×σ2.

5. The electrode group according to claim 1, wherein the composite membrane includes a composite layer and a non-woven fabric or a self-standing porous membrane, and further includes a base material layer in contact with the composite layer.

6. The electrode group according to claim 1, wherein the inorganic solid particles include solid electrolyte particles having ionic conductivity of alkali metal ions.

7. The electrode group according to claim 1, wherein the inorganic solid particles are at least one selected from the group consisting of a compound represented by Li_{1+w}Al_{w}Ti_{2-w}(PO₄)₃, in which 0.1≤w≤0.5, a compound represented by Li_{1+y}Al_{z}M1_{2-z}(PO₄)₃, in which M1 contains one or more selected from the group consisting of Ti, Ge, Sr, Zr, Sn, and Ca, and 0≤y≤1 and 0≤z≤1, and a compound represented by Li₅₊ₓLa₃M2₂₋ₓZrO₁₂, in which M2 contains one or more selected from the group consisting of Nb and Ta and 0≤x≤2.

8. The electrode group according to claim 1, wherein the polymer material contains a monomer unit made of a hydrocarbon having a functional group containing one or more selected from the group consisting of oxygen (O), sulfur (S), nitrogen (N), and fluorine (F), and a ratio occupied by the monomer unit in the polymer material is 70 mol % or more.

9. The electrode group according to claim 8, wherein the functional group of the monomer unit contains one or more selected from the group consisting of a formal group, a butyral group, a carboxymethyl ester group, an acetyl group, a carbonyl group, a hydroxyl group, and a fluoro group.

10. The electrode group according to claim 1, wherein the active material-containing layer contains a negative electrode active material containing a compound wherein the compound's lithium ion insertion-desorption potential is 1 V or more and 3 V or less (vs. Li/Li⁺) with respect to a oxidation-reduction potential of lithium.

11. The electrode group according to claim 1, wherein the positive electrode active material-containing layer contains a positive electrode active material containing a compound wherein the compound's lithium ion insertion-desorption potential is 2.5 V or more and 5.5 V or less (vs. Li/Li⁺) with respect to the oxidation-reduction potential of the lithium.

12. A secondary battery comprising:
the electrode group according to claim 1; and
an aqueous electrolyte containing water.

13. A battery pack comprising the secondary battery according to claim 12.

14. The battery pack according to claim 13, further comprising: an external terminal for energization and a protection circuit.

15. The battery pack according to claim 13, wherein a plurality of secondary batteries are included, and the plurality of secondary batteries are electrically connected in series, in parallel, or in combination of series and parallel.

16. A vehicle comprising the battery pack according to claim 13.

17. The vehicle according to claim 16, further comprising: a mechanism that converts kinetic energy of the vehicle into regenerative energy.

18. A stationary power supply, comprising the battery pack according to claim 13.
